(19) United States
(12) Patent Application Publication
(10) Pub. No.: US 2020/0349751 A1
(43) Pub. Date: Nov. 5, 2020

(54) PRESENTATION INTERFACE AND IMMERSION PLATFORM

(71) Applicant: Number 9, LLC, New York, NY (US)

(72) Inventors: Lyron L. Bentovim, Demarest, NJ (US); James J. Giliberti, San Francisco, CA (US); Howard Olah-Reiken, Hoboken, NJ (US)

(21) Appl. No.: 16/863,302

(22) Filed: Apr. 30, 2020

Related U.S. Application Data
(60) Provisional application No. 62/840,802, filed on Apr. 30, 2019.

(51) Int. Cl. G06T 13/40; G06T 19/20; H04N 7/15

(52) U.S. Cl. CPC G06T 13/40; H04N 7/157; G06T 19/20

(57) ABSTRACT

A virtual reality system is disclosed herein. The system includes a viewing device suitable for displaying display information from a virtual reality environment. The system includes a capture device configured to capture a real world activity. Information is received from the capture device related to a real world activity. The information is transmitted to the virtual reality environment generation system for converting the information to a corresponding streaming asset that is embedded into the virtual reality environment for subsequent transmission to an instance of the virtual reality environment on a participant device. Virtual reality environment information is received from the virtual reality environment generation system. The virtual reality environment information corresponds to the position or orientation of a participant asset of a participant that is engaging with the streaming asset. The participant asset is displayed on the viewing device.

### CROSS-REFERENCE TO RELATED APPLICATION

This application claims priority to U.S. Provisional Application No. 62/840,802, filed on Apr. 30, 2019, the disclosure of which is incorporated by reference herein in its entirety.

### TECHNICAL FIELD

A system for displaying a simulated reality system, more particularly, one that combines the simulated reality environment with a live feed of a presentation while allowing for communication between viewers and communication between viewers and presenter.

### BACKGROUND

Traditional multiuser virtual reality systems allow users to interact with other users who appear to be co-located even though they may actually be in different physical locations. In such systems, the users appear in the same immersive environment and may communicate with each other and interact with shared aspects of the environment. The users use some type of virtual reality head mounted display. However, these systems do not address the need for group interactions between a presenter and attendees, such as a teacher and students, a manager and employees, a medical practitioner and patients, etc. These interactions are sometimes challenged by scheduling and distance. More and more individuals are deciding to work from home, take classes from experts in other cities, or confer with doctors in other countries. Collaboration between teams that are spread across states or even continents is becoming more the rule rather than the exception. Interaction with other attendees is often as important as seeing/hearing the presenter.

### SUMMARY

In accordance with various embodiments, a simulated reality system is provided. Disclosed herein are procedures, tools, and methods for a system suitable for the capture, distribution, and display of interactive mixed reality content. This includes the ability for attendees to interact with each other as well as the presenter in a live environment. In various embodiments, a method of near real-time communication is provided. The method increases both the sense of presence and connectedness between a presenter and attendees that provides for a high degree of interaction between local and remote attendees.

In accordance with various embodiments, a virtual reality system is disclosed herein. The system includes a viewing device suitable for displaying information from a virtual reality environment. The system includes a capture device configured to capture a real world activity. Information is received from the capture device related to a real world activity. The information is transmitted to the virtual reality environment generation system for converting the information to a corresponding streaming asset that is embedded into the virtual reality environment for subsequent transmission to an instance of the virtual reality environment on a participant device. Virtual reality environment information is received from the virtual reality environment generation system. The virtual reality environment information corresponds to the position or orientation of a participant asset of a participant that is engaging with the streaming asset. The participant asset is displayed on the viewing device.

In one or more scenarios, a virtual reality system includes a viewing device suitable for displaying information from a virtual reality environment having a participant controlled asset, and a streaming asset having updatable content, and an information transmission device in communication with a virtual reality environment generation system suitable for generating the display information for display on the viewing device defining the virtual reality environment. The virtual reality system also includes one or more controls or sensors suitable to allow a user to interact with the virtual reality environment. The system includes a processor configured to display and adjust the display information in the virtual reality environment by transmitting information related to position or activity of the avatar to the virtual reality environment generation system for subsequent transmission to be displayed at a location of capture of the streaming asset, and receiving information from the virtual reality environment generation system that updates the streaming asset content.

In some embodiments, the one or more controls or sensors can be an input device configured to adjust the participant controlled asset within the virtual reality environment. Optionally, the participant controlled asset is an avatar representation of the participant for display in the virtual reality environment. A participant can affect the streaming asset content by changing the position or activity of the participant's avatar. The system may also receive information from the virtual reality environment generation system that locates additional avatars in the virtual reality environment that are also are experiencing the streaming asset.

In certain embodiments, the streaming asset may include content from a real world event. For example, the streaming asset may be a video feed of a portion of a captured live presentation. Optionally, the streaming asset may be updated in near real-time based on progress of the presentation.

In certain scenarios, a content capture system for creating a virtual reality asset in near real-time is disclosed herein. The system includes a viewing device suitable for displaying information from a virtual reality environment, a capture device configured to capture a real world activity, and an information transmission device in communication with a virtual reality environment generation system suitable for generating display information for display on the viewing device defining some portion of the virtual reality environment. Information is received from the capture device related to a real world activity. The information is transmitted to the virtual reality environment generation system for converting the information to a corresponding streaming asset that is embedded into the virtual reality environment for subsequent transmission to an instance of the virtual reality environment on a participant device. Virtual reality environment information is received from the virtual reality environment generation system. The virtual reality environment information corresponds to the position or orientation of a participant asset of a participant that is engaging with the streaming asset. The participant asset is displayed on the viewing device.

In some embodiments, the participant asset is an avatar representation of a participant viewing the streaming asset content. Optionally, the streaming asset may be transmitted in near real-time as the presentation progresses.

In other embodiments, the streaming asset is a video feed of the real world event such as a presentation.

In certain embodiments, the participant asset display on the viewing device may be continually updated allowing feedback for the participant's engagement with the streaming asset.

In at least one embodiment, the participant is a first participant having a first participant asset. Optionally, the system may also receive additional information from the virtual reality environment generation system corresponding to the position or orientation of a second participant asset of a second participant that is engaging with the streaming asset. The system can also display the second participant asset on the display device. Optionally, the system may receive biographical information from the virtual reality environment generation system corresponding to the first participant or second participant, and/or display the biographical information on the display device relative to the corresponding first participant or second participant.

In some other scenarios, a virtual reality system for partitioned virtual reality environments is described. The system may include a viewing device suitable for displaying display information from a virtual reality environment having a participant controlled asset, and a streaming asset, and an information transmission device in communication with a virtual reality environment generation system suitable for generating the display information for display on the viewing device defining the virtual reality environment. The system also includes one or more controls or sensors suitable to allow a user to interact with the virtual reality environment. The system further includes a processor configured to display and adjust the display information in the virtual reality environment by locating the participant controlled asset in a virtual region in the virtual reality environment, locating the streaming asset within the virtual reality environment but outside of the virtual region such that the participant controlled asset is partitioned from the streaming asset. The virtual region includes one or more virtual assets that the participant controlled asset can engage with. The processor may also receive information from the virtual reality environment generation system that updates the streaming asset content.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several examples in accordance with the disclosure and are, therefore, not to be considered limiting of its scope, the disclosure will be described with additional specificity and detail through use of the accompanying drawings, in which:

FIG. 1 illustrates a schematic diagram of a simulated reality system;

FIG. 2 illustrates a schematic diagram of a server included in the simulated reality system of FIG. 1.

FIGS. 3A, 3B, and 3C illustrate an example of a viewer platforms displaying a simulated reality environment around a live feed asset in accordance with various embodiments disclosed herein;

FIGS. 4A, 4B, and 4C illustrate another example of a viewer platforms displaying a simulated reality environment having a live feed asset contained therein in accordance with various embodiments disclosed herein;

FIGS. 5A, 5B, and 5C illustrate another example of a viewer platforms displaying a simulated reality environment having a live feed asset contained therein in accordance with various embodiments disclosed herein;

FIGS. 6A, 6B, and 6C illustrate another example of a viewer platforms displaying a simulated reality environment having a live feed asset contained therein in accordance with various embodiments disclosed herein;

FIGS. 7A and 7B illustrate schematic overhead diagrams of an example of a presentation blended with a simulated reality environment;

FIG. 7C illustrate schematic overhead diagrams of an example of a presentation with a view of a simulated reality environment;

FIGS. 8A and 8B illustrate schematic overhead diagrams of an example of a presentation blended with a simulated reality environment;

FIG. 9A illustrates an perspective view of an illustrated presenter system setup with local participants;

FIGS. 9B, 9C and 9D illustrate various examples of participant displays on the presenter display devices; and

All figures are arranged in accordance with at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative examples described in the detailed description, drawings, and claims are not meant to be limiting. Other examples may be utilized, and other changes may be made, without departing from the spirit or scope of the subject matter presented herein. It will be readily understood that the aspects of the present disclosure, as generally described herein and illustrated in the Figures, can be arranged, substituted, combined, separated, and designed in a wide variety of different configurations, all of which are implicitly contemplated herein.

The system and methods disclosed herein allow the presenter to identify and engage with remote participants. In doing this, the participants can engage with a visual and audio display of the presenter (streaming asset) and the presenter can engage with participant controlled assets (e.g. avatars or other representations of the participants). The representations can include images, audio, and/or biographical information of the participants. Specifically, a streaming asset is assigned a location, orientation, and/or size in a simulated reality environment and presented to an avatars, from the perspective of the avatar's location in the virtual reality environment. Similarly, an avatar is assigned a location, orientation, and/or size in a simulated reality environment, and the presenter can view the virtual reality environment and the avatars contained therein from the perspective of the streaming asset's location within the virtual reality environment.

Simulated reality systems render environments that can be either partially or entirely virtual. One type of simulated reality system is a virtual reality (VR) system, which includes VR environments that are three-dimensional (3D) representations of real or virtual worlds. Virtual reality systems can be displayed on two-dimensional (2D) devices such as a computer screens, mobile devices, or other suitable 2D displays. Virtual reality systems can also be displayed in 3D such as on a 3D displays (e.g. 3D screens, WebVR, Virtual Reality headsets, etc.) or a hologram. Examples of virtual reality can also include traditional 3D representations on 2D displays. In VR environments, the user experiences a virtual world. Some types of virtual reality system may have assets that are simulations of (i.e., corresponds to) real world items, objects, places, people, or similar entities shown in the virtual reality environment such as, without limitations, avatars, clones, images, schematic representations, symbols, or the like. Another type of simulated reality system is an augmented reality system, which includes a display feed of a real environment overlaid or otherwise blended with one or more virtual assets. Specifically, a simulated reality system of this disclosure may render a simulated reality environment that be a virtual reality environment and/or an augmented reality environment.

A system for displaying a simulated reality environment is provided herein. In accordance with various embodiments discussed herein, the system allows a user to manipulate perspectives of his/her virtual reality environment while communicating this change in perspective to other users or connected devices of the system by reflecting those changes (via, for example, asset reorientation) viewable in the virtual reality environment of such other users. Additionally or alternatively, the changes in the perspective of the virtual reality environment of a user can also be viewed by users not engaged in the simulated reality environment. An example of one such user could be a presenter utilizing the simulated reality environment to display a live or near-live feed to other users of the simulated reality environment.

In accordance with various embodiments, the system disclosed herein allows one or more users on non-immersive display devices (e.g. phones, tablets, laptops, desktops, etc.) to participate with and collaborate with one or more immersive display device users in a simulated reality environment. These multi-user cross platform experiences can be applicable to, but are not limited to, live events such as meet-ups, sporting and eSports events, theatrical events, educational lectures, support groups, demonstrations, productivity meetings, etc. In various embodiments, the systems disclosed here can also allow for a participant (non-immersive or immersive) to experience a solo virtual reality environment.

In accordance with various embodiments, the systems disclosed herein allow a user to join simulated reality sessions, using an application on an immersive or non-immersive devices. In accordance with various embodiments, immersive devices can emulate a user's head, body, and/or hand position. The position of the head, body, and/or hands can be represented in the simulated reality environment such that other users see the virtual position of the emulated user position. In some embodiments, the position of the non-immersive device can also manipulate the perspective by which the user views the virtual reality environment via the non-immersive device and/or other users see the virtual position of a user associated with the non-immersive device in the virtual reality environment. Such manipulation can be accomplished when using movable devices, such as smart phones, tablets, and augmented reality glasses. In such embodiments, a user can move their device around them, looking in any direction, and see on their device's screen, that portion of the virtual reality environment that would be seen were the user in the virtual reality system looking in that direction. The correct position, orientation, and point of view of the user may be determined by input from the devices sensors (described below). In accordance with various embodiments, to the users using the system from immersive devices such as headsets, any non-immersive user appears as a participant controlled asset (e.g. avatar) with that participant controlled asset having position, orientation, and movement within the environment. The position of the head and/or hands of the participant controlled assets may be positioned relative to where the user is holding the device. In some embodiments, additional adjustments to the head and/or hands may be made via user input elements and/or input devices.

In various embodiments, multi-user simulated reality systems include instances of virtual reality applications that communicate with other instances of the virtual reality application that may be registered with the same server and whose users may have entered the same shared environment on that server. This allows the system to communicate which assets should appear cloned in other running instances of the same application (i.e., shared assets). The shared assets can include avatar features (e.g., hands, head, body, or other features) that are representative of real world users in the virtual environment. The shared assets may also include any assets in the environment that all users need to see as the same asset, and to manipulate in ways that others can observe as well. Persons of ordinary skill in the art can utilize the disclosure herein in accordance with their understanding to implement the various aspects, embodiments, or examples of the disclosure. For example, implementation can include using one or more systems, processes, or methods of network computing including Remote Procedure Calls (RPC's), Representational State Transfer (REST), Simple Object Access Protocol (SOAP), ruby, java script, websockets, and/or any other suitable systems, processes, or methods of network computing. As an example, the system can use Remote Procedure Calls (RPC's) often wrapped in convenience functions or facilitated by platforms. The system can also use RPC's to communicate changes that affect other running instances of the application, and to pass audio and textual data, which enable users to hear each other and chat with each other within or relative to the interactions of the simulated reality environment.

In accordance with various embodiments, instances on non-immersive devices will be able to send and receive analogous RPC's so that non-immersive device users and immersive device users see each other in comparable contexts and can interact with shared assets similarly or equally (without being aware of the type of device other users are using). Simulated reality instances on non-immersive devices and simulated reality instances on immersive devices can also remain in sync with respect to any state changes. This cross platform functionality stands in contrast to traditional systems that share and sync state changes amongst immersive instances. In various embodiments, audio and text data can also be shared comparably amongst simulated reality instances for non-immersive devices and virtual reality instances for immersive devices.

In accordance with various embodiments, the non-immersive instances register with the server the same way the immersive instances do. In some embodiments, the non-immersive instances use functions and utilities to send and receive RPC's that appear to the receiver in the same way the existing immersive versions do. As an example, in some instances, the rotation of a handheld mobile phone or tablet will be transmitted in a way that will be interpreted in the same way as the rotation of a user's head in a VR headset would. As a result, the phone or tablet user will see parts of the virtual world that would be seen if looking in that direction, and users using immersive devices (e.g., VR headsets) will see phone or tablet user's participant controlled asset head move as though that user were turning their head in an actual headset. Virtual environments in the immersive experience will be adapted to and provided for display and interaction in the non-immersive instances.

In accordance with various embodiments, the simulated reality environments and the assets (avatars, objects, etc.) can be displayed for individuals not actively experiencing (e.g. residing in, or otherwise having participant controlled asset such as an avatar) in the simulated reality environment. For example, a presenter may be able to view the simulated reality environment (including, for example, avatars of viewers of the presentation in a simulated reality environment) from at least one perspective. However, as discussed below, the presenter can have a variety of views of the simulated reality environment and/or the participants therein. In some embodiments, the presenter's view of the simulated reality environment can differ from the participants perception of the same. Additionally or alternatively, the users engaged with the simulated reality environment can likewise view the presenter via a display stream providing a real-time, or near real-time feed of the presentation.

The systems and methods described herein provide a presentation platform that allows the presenter to engage with both local participants in the real world and remote participants in a simulated environment (presentation viewers) simultaneously in near real-time interactive sessions. The elements of the system may include hardware that provides capture and viewable dissemination of the presentation. The hardware, specifically the capture device or devices, can be placed relative to the local presentation viewers to convey an authentic environment for the presenter, the local viewer, and/or the remote viewer perspectives. This environment may allow the presenter to feel as connected and engaged with the participants attending remotely as the local viewers that can be in the room with the presenter. This environment may likewise allows the remote participants to feel like they are as similarly disposed to enjoy all of the benefits of the presentation as the local viewers.

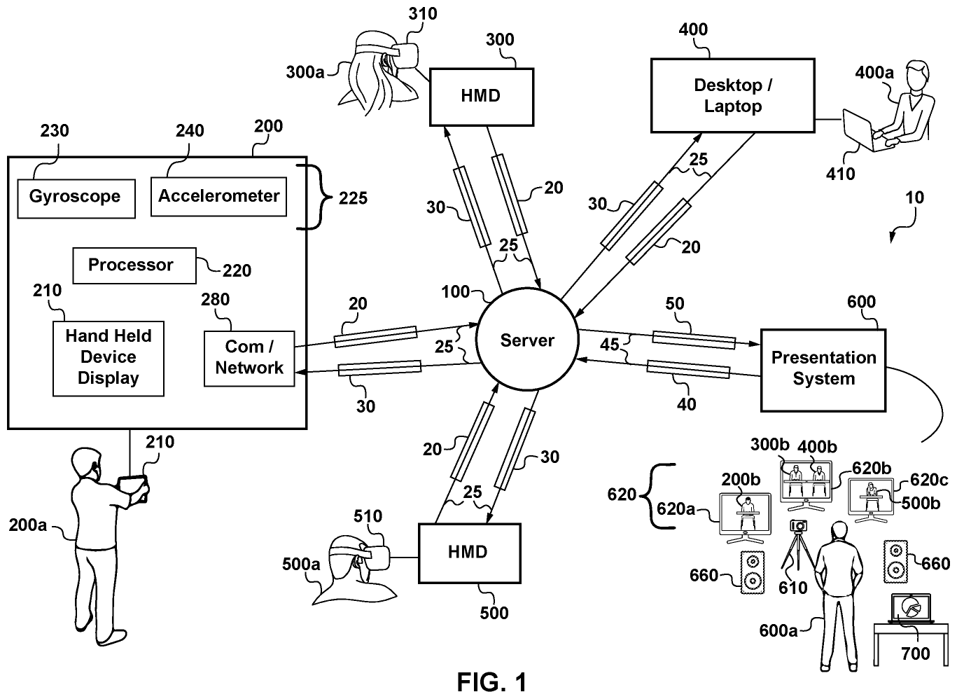

FIG. 1 illustrates a schematic diagram of the presentation interface and immersion platform 10. In accordance with various embodiments, as illustrated in FIG. 1, a presentation interface and immersion platform 10 includes one or more remote participants (e.g. 200a, 300a, 400a, 500a) in interactive communication with a presenter 600a. In various embodiments, the remote participants and the presenter may be in communication with each other via a simulated reality system server 100. Each remote participant (e.g. 200a, 300a, 400a, 500a) may transmit a representation of themselves (e.g. their own image or that of an avatar) back to the presenter's display 620. In various embodiments, this is done via the server 100. In various embodiments, the presenter 600a may be engaged with local live participants (not shown here) in addition to the remote participants (e.g. 200a, 300a, 400a, 500a). Software places the remote participants (e.g. 200a, 300a, 400a, 500a) in specific locations within the simulated reality environment. In some embodiments, the simulated reality environment can be configured to provide a field of view that is the same as or similar to the field of view that the local participants have of the presenter. The system and methods disclosed herein allow the presenter 600a to identify and engage with the representations (e.g. 200b, 300b, 400b, 500b) of the remote participants (e.g. 200a, 300a, 400a, 500a). In various embodiments, the system includes the optional display of pertinent data about the attendee on the presenter's display 620, such as name, interest, location, etc. so that the presenter can be more engaged and focused with the interaction with the remote participant.

In accordance with various embodiments, as depicted in FIG. 1, multiple remote participants (e.g. 200a, 300a, 400a, 500a) can operate across different device platforms utilizing the presentation interface and immersion platform 10 to generate a shared simulated reality environment that also includes the real-time or near real-time presentation as an asset. The real-time or near real-time presentation can be viewed by one or more of the remote participants (e.g. 200a, 300a, 400a, 500a) within the simulated reality environment. The system may determine a location, size and/or orientation of an asset corresponding to the presenter (i.e., the streaming asset) in the virtual reality environment, which can be viewed by the remote participants for an immersive experience, as described below.

In accordance with various embodiments, the presentation interface and immersion platform 10 includes one or more participant systems (e.g. 200, 300, 400, 500). The presentation interface and immersion platform 10 may include a participant communication system 25 between a participant system (e.g. system 200) and other participant systems (e.g. 300) and/or a participant system (e.g. 200, 300, 400, 500) and the server 100. In various embodiments, the participant systems (e.g. 200, 300, 400, 500) are in communication with each other via the server 100. The presentation interface and immersion platform 10 is shown in FIG. 1 as including four participant systems, it is, however, appreciated that both fewer and more participant systems can be included and four was merely selected as an example.

In accordance with various embodiments, the presentation interface and immersion platform 10 includes a presenter system 600. The presenter system 600 may include a presenter communication system 45 allowing the presenter system 600 to communicate with one or more of the participant systems (e.g. one or more of 200, 300, 400, 500). In various embodiments, this communication is performed via the server 100. The presentation interface and immersion platform 10 is shown in FIG. 1 as including a single presenter system 600, it is, however appreciated that the immersion platform 10 can host multiple presentation systems allowing participants to choose between the multiple presentation systems and select and engage with an instance with the presentation of their choice. In accordance with one embodiments, this choice is accomplished by navigating between presentations in the simulated reality environment. In another embodiment, this choice is accomplished by any other suitable method such as selecting the preferred presentation instance from a list of available presentation instances.

In accordance with various embodiments, the presenter system 600 captures and transmits presenter data 40 from the presenter system 600 to the participant system(s) (e.g. one or more of 200, 300, 400, 500). In an embodiment, this is done by transmitting the presenter data 40 to the server 100. The presenter data may include a real-time or near real-time stream of the presenter's 600 presentation including one or more of video, sound, and secondary visual or audio display 700.

Real-time presentation is one in which the presentation is transmitted to the participants as directly and quickly as possible and being limited only by bandwidth and processing time delays inherent in the system. A near real-time stream is one in which the presentation is transmitted within a time frame in which the participant still feels like the experience is being performed live or in real-time and in which the interaction between the participant and the user occurs while the presentation is still occurring.

In accordance with various embodiments, the server 100 receives the presenter data 40 and performs post processing as necessary to prepare the presenter data for embedding into the simulated reality environment for consumption by the participants. For example, the presenter data may be embedded into a virtual reality environment as an asset corresponding to the presenter. While discussed herein generically as a simulated reality environment, in a preferred embodiment, the presentation interface and immersion platform 10 specifically generates a virtual reality environment providing for a more immersive experience to the participants than what is provided in an augmented reality or mixed reality environments. It is however, appreciated that the presentation system can capture a suitable asset of the presenter data that can be merged with augmented reality or mixed reality environments. For the sake of clarity, the system will be discussed below in terms of virtual reality but understanding that persons of ordinary skill in the art can adapt the disclosure herein for application to augmented reality and mixed reality environments.

In preferred embodiments, the presenter data 40 is embedded into the virtual reality environment at the server and then the virtual reality environment (personalized for each participant) is communicated to the corresponding participant systems via environment data stream 30 for display on the participant device displays (e.g. 210, 310, 410, 510). In another embodiment, the environment data 30 is sent separately as the simulated reality environment and the participant stream is sent separately such that the participant stream is embedded in the environment at the participant system (e.g. 200, 300, 400, 500).

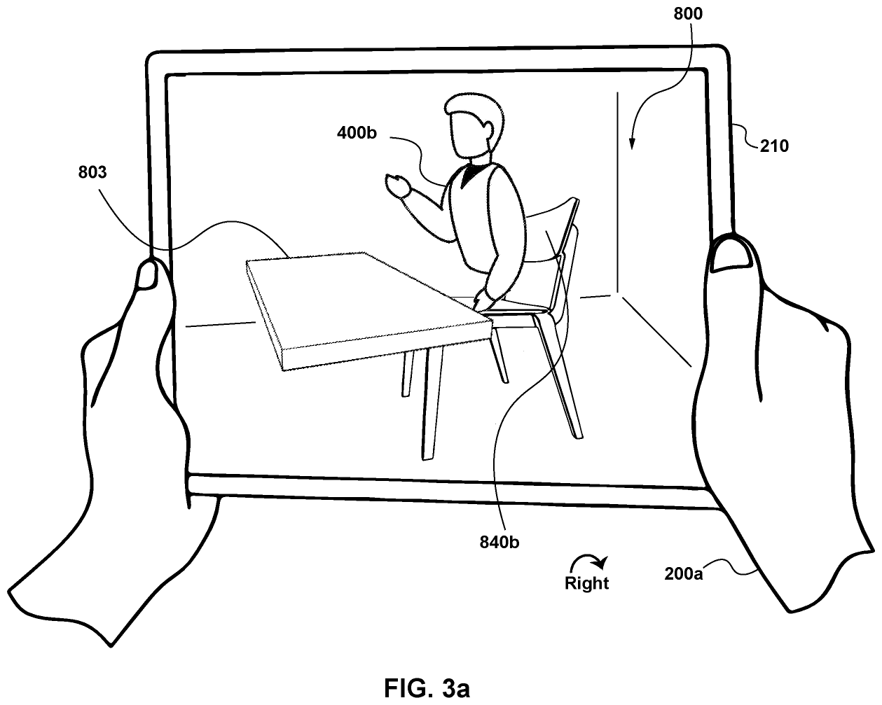

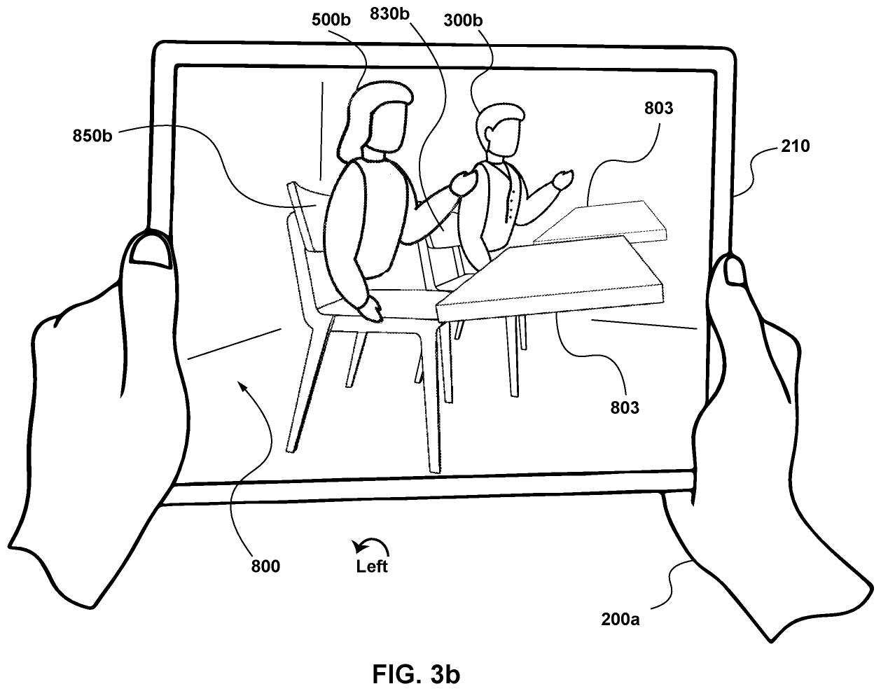

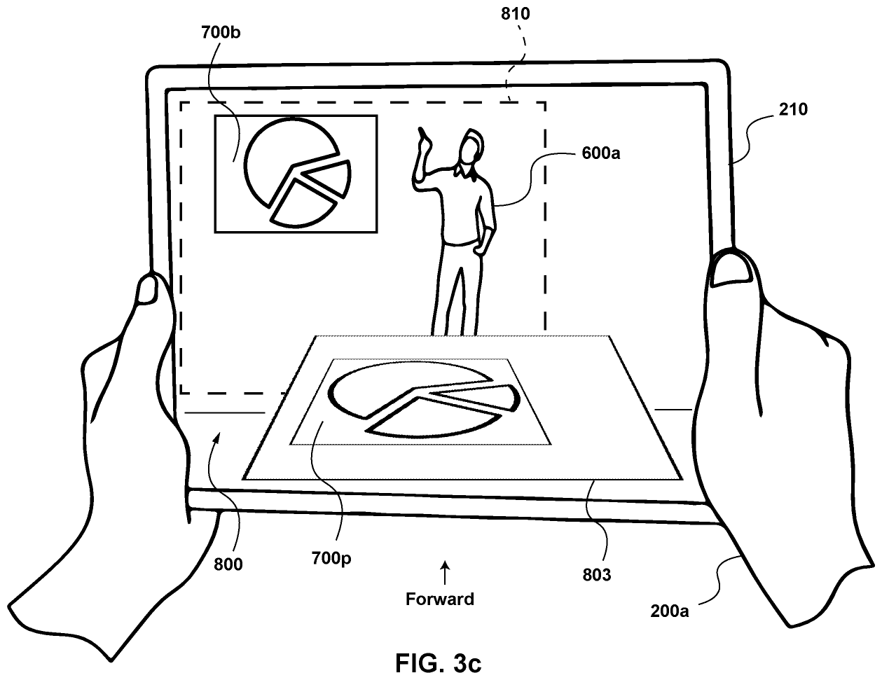

As the presenter 600a and various participants (e.g. 200a, 300a, 400a, 500a) can view their corresponding versions of the shared virtual reality environment, each participant's interaction with the virtual reality environment changes the various relationships, views, perspectives, or the environment itself for the interacting participant as well as other participants and the presenter. Thus for the presenter 600a and other participants to see these changes as continuous updates to the virtual reality environment, the remote participant systems (e.g. 200, 300, 400, 500) may transmit these changes from the participant system that is the source of the change to the presentation interface and immersion platform 10 as individual participant data 20 allowing the other participants and the presenter to see how the specific participant has changed the system. In various embodiments, the individual participant data 20 is transmitted to the server 100. At the server 100 the environmental simulated reality generator (SR generator) 146 may update the virtual environment and then transmit that information back to the remote participants as part of the environmental data stream 30 allowing the remote participants (e.g. 200a, 300a, 400a, 500a) to experience changes to the virtual reality environment based on other participants interaction with that environment. In one example, the virtual reality environment includes a virtual area with multiple seats as shown in FIG. 3B. The avatar of participant 200a can move from the location of one seat to the location of another seat in response to, for example, detection movement of the device 200, user input from the user, etc. This change in participant 200a's avatar location can then be communicated to the presenter and the other participants so that each of them can see the move from their respective perspectives. In other examples, the change may be small such as the participant 200a's avatar may stop looking in the direction of the presentation and may look at another participant. This change can be transmitted throughout the virtual reality system such that the other participants and the presenter can see where participant 200a's avatar is looking.

In accordance with various embodiments, the individual participant data 20 can include one or more types of information including, changes to the environment (as discussed above), participant profile information, participant captured information (e.g. voice or expressions), communicative information (e.g. text, comments, answers, poll responses, questions, or graphical contributions to the presentation), or other suitable information that one participant chooses to share with the other participants or the presenter.

The server 100 can also aggregate the various streams of remote individual participant data 20 from one or more remote participants and prepare the data for display on the presenter system 600. For example, each remote individual participant data 20 stream can be aggregated in an aggregate data 50 stream and prepared for viewing on the presenter viewing device 620. The aggregated streams can be prepared in such fashion to make the consumption easier for the presenter. As such, the displayed aggregate data 50 can be one that reflects a modified version of the virtual reality environment, includes only a portion of the VR environment, includes only the movement or gesticulations of the avatar, or additionally and/or alternatively includes only a suitable amount of information to allow the presenter to interact directly with the individual participants as desired. Examples, of modified presenter views are discussed in more detail below. The aggregate data 50 may include all of or merely a subset of the individual participant data 20 discussed above but aggregated from all of the participants.

In accordance with various embodiments, the system for generating a simulated reality environment 10 can include a plurality of different users from different platforms to access the same simulated reality environment. For example, the system 10 can include a viewing device (e.g. 210, 310, 410, and/or 510) suitable for displaying display information of the simulated reality environment generated by the system 10 to a participant. The viewing devices can include one or more of non-immersive viewers (e.g. 200a via display 210, 400a via display 410, etc.) and/or immersive viewers (e.g. 300a via 310, 500a via 510, etc.). Non-immersive display devices can include, for example, smart phones, tablets, laptops, desktop computers, smart TV's, and/or similar suitable viewing devices. Immersive display devices can include virtual reality head-mounted displays (HMD). Examples of virtual reality and/or augmented reality glasses include HoloLens, Magic Leap, Vusix, virtual reality glasses, etc. Examples of virtual reality HMDs include mobile devices (e.g., Oculus Go, Oculus Quest, Pico, Vive Focus, etc) and high-end computer-tethered devices (ex. Oculus Rift, HTC Vive, HTC Vive Pro, Windows Mixed Reality). Additionally or alternatively, one or more of the viewing devices can be handheld movable devices such as smart phones, tablets, etc. Notably, the handheld movable devices can be a subset of the non-immersive viewers. In various embodiments, the participants (e.g. 200a, 300a, 400a, 500a) including a variety of viewing devices (e.g. 210, 310, 410, and/or 510) can all share a single instance of a simulated reality environment.

In accordance with various embodiments, the presentation interface and immersion platform 10 can include a plurality of different users utilizing a similar platform to accesses an instance of the simulated reality environment. For example, the system 10 includes a plurality of users having immersive devices (e.g. HMDs.) In another example, the system 10 includes a plurality of users having non-immersive devices. In another example, the system 10 is configured to partition participates having immersive devices (e.g. HMDs) with other participants having immersive devices and participants having non-immersive with other participants having non-immersive devices.

In accordance with various embodiments, the presenter 600a engages with the presentation interface and immersion platform 10 via a presentation system 600. The presentation system 600 includes capture hardware 610 and a participant display 620 (e.g. 620a, 620b, 620c). While shown in FIG. 1 as multiple participant displays 620a, 620b, 620c, it is contemplated that a single display can be used, two displays can be included or more displays than what is depicted can be included.

In accordance with various embodiments, the capture hardware 610 may include a camera. For example, the cameras can include those associated with capturing feeds usable for display in a simulated reality environment such as a virtual reality environment. In an example, the capture device 610 is a stereoscopic 180 degree camera (“VR180”) that provides an immersive experience since the image is 3D. In other examples, 360 Degree cameras can also be used in this system and provide a method for capturing local participants attending the session as well.

In accordance with various embodiments, the entire environment behind the presenter 600a is captured. In accordance with various embodiments, a camera included in the capture hardware 610 is set up in a location suitable to represent the remote participant if the participant was local. The camera 610 can capture the presentation and transmits at least a portion of presentation to the participant (e.g. 200a, 300a, 400a, 500a). In some embodiments, the entire captured field of view of the camera 610 is transmitted. In other embodiments, only a portion of the field of view of the camera 610 is transmitted to the participant (e.g. 200a, 300a, 400a, 500a). In various embodiments, the captured data is transmitted to the server 100. The captured data may be modified such that only a portion of the captured data (e.g., only the presenter 600a without any background) is eventually presented in the simulated reality environment as an asset for the remote participant (e.g. 200a, 300a, 400a, 500a) to view therein. In various embodiments, the post processing step of modifying the captured data is performed at the server 100. In various embodiments, the presenter may use a green screen or alternative “keying” methods in the capture process in order to simplify the post process modification of the captured data so that it can be inserted into the simulated reality environment easier. The captured data is then processed by software modules (at the presenter system 600 or server 100) to allow for the processed captured data to be transmitted over the internet to remote clients and viewed in the simulated reality environment on the participant display devices (e.g. tablets, head mounted displays smartphones, hololens, etc.).

The capture hardware 610 may also include sound capture in addition to video/image capture. In various embodiments, the capture hardware 610 includes a microphone suitable to capture the presenter's 600a sound and transmit the sound along with the captured video to the remote participants (e.g. 200a, 300a, 400a, 500a). In various embodiments, the camera 610 captures the sound along with the video of the presenter. In other embodiments, the capture elements are separate.

The participant display 620 (e.g. 620a, 620b, 620c) can include a video monitor suitable to display a version of the simulated reality environment occupied by the participants (e.g. 200a, 300a, 400a, 500a). In this way, the presenter 600a can have visual feedback from the remote participants (e.g. 200a, 300a, 400a, 500a) based on their representations (e.g. avatars 200b, 300b, 400b, and 500b) within the simulated reality environment.

The participant display 620 can also include or be coupled with a sound distribution device 660 suitable to provide a sound transmission from the remote participants (e.g. 200a, 300a, 400a, 500a). The sound distribution device 660 can be speakers, headset, or any other suitable sound distribution system. In various embodiments, the sound distribution is configured to blend the participation of the remote participants with the local environment including the local participants if they are present.

The system 10 can include a simulated reality system server 100 in communication with one or more remote users, for example with an immersive device 300 used by a user 300a. The server 100 can also be in communication with a non-immersive device 200 used by a user 200a. The communication between the non-immersive device 200 and the server 100 can include the communication system 25 connected via the com network module 280. The communication between the presenter system 600 and the server 100 can include the transmission paths 45.

In various embodiments, each of the remote participant devices (e.g., 200, 300, 400, 500, etc.) can include one or more controls suitable for positioning the participant in the simulated reality environment. While discussed herein in reference to the handheld system 200, one or more of the various aspects, embodiments, and examples discussed below can also apply to the other remote participant systems (e.g. 300, 400, 500). In various embodiments, the non-immersive viewing device 200 can include sensors 225, including, for example, the gyroscope 230 and the accelerometer 240. The viewing device 200 can include the processor 220, similar to the processors discussed below with regards to another processor 120. The viewing device 200 can also include a display 210.

In accordance with various embodiments, the various remote participant devices can include some sort of sensor or control feature suitable to allow the participant representation to interact with the virtual environment. For example, the immersive devices (e.g. 300 and 500) can include similar hardware common in HMDs or the like that allow HMDs to interact with, manipulate, or otherwise navigate the virtual reality environment. Other devices like the laptop 410 may include physical controls (e.g. buttons, mouse, game controllers, etc.) for the participant to interact with, manipulate, or otherwise navigate the virtual reality environment.

These participant sensors (e.g. sensor 225) or controls can produce manipulation data that can be combined with the individual participant data 20 that is transmitted to the server 100 as illustrated in FIG. 1. The logging of remote participation can include data related to such characteristics as position and orientation within the virtual environments, items and participants the attendee has interacted with, questions asked, responses given, distractions from other participants, etc., and provides feedback to the presenter 600a, allowing the presenter 600a to improve the presentation on the fly.

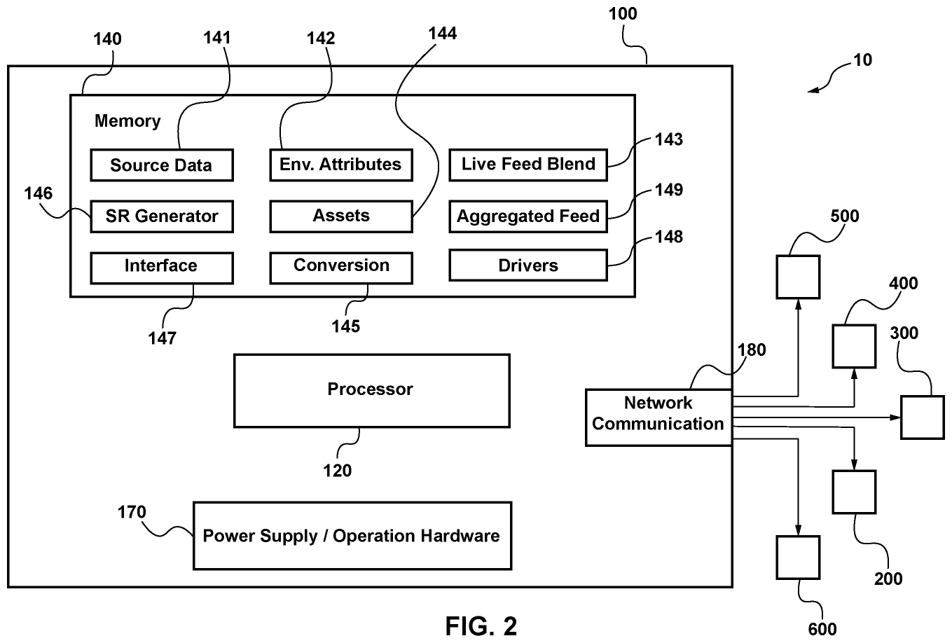

FIG. 2 as discussed above is a schematic diagram of the virtual reality display system server 100. The server 100 can support and implement a portion of the systems illustrated in the other figures shown and discussed herein or can support and implement all of the systems illustrated in the other figures shown and discussed herein. For example, the server 100 may be a part of a single device or may be segregated into multiple devices that are networked or standalone. The server 100 need not include all of the components shown in FIGS. 1 and/or 2 and described below.

The system 100 includes one or more memory storage devices 140. In various embodiments, the memory storage device 130 may include a non-transitory memory containing computer-readable instructions operable to the display and adjust the display of information in a virtual reality environment.

In accordance with various embodiments, as illustrated in FIG. 2, the server 100 includes one or more processing elements 120, one or more memory components 140, a power source 170, a networking/communication interface 180, and/or other suitable equipment for implementation of a virtual reality environment, with each component variously in communication with each other via one or more system buses or via wireless transmission means. Each of the components will be discussed in turn below. The memory components 140 can include one or more of source data 141, environmental attributes 142, live feed blend 143, asset data 144, virtual reality generator 146, interface 147, conversion module 145, drivers 148, and aggregated feed 149.

In accordance with various embodiments, the capture information 40 (e.g. captured audio, captured video, other presentation display 700, etc.) of the presenter is distributed to the remote participants (e.g. 200a, 300a, 400a, 500a). In addition, the aggregate remote participant information 50 (e.g. audio, video, profile, or other data) from the remote sites or server 100 may be transmitted back to the presenter system 600 and may utilize the network bandwidth. With an adaptive degradation algorithm it is appreciated that representations of individuals can be first reduced in resolution, then reduced in image type (e.g. from photoreal to graphic images), and then reduced to audio only for those in participation across the network to maintain suitable utilization of the bandwidth to maintain near real-time presentation. In accordance with various embodiments, captured information 50 (e.g. the video and the audio of the presenter) and the environment data 30 from the server 100 to the remote participants (e.g. 200a, 300a, 400a, 500a) takes priority in any contention for network bandwidth.

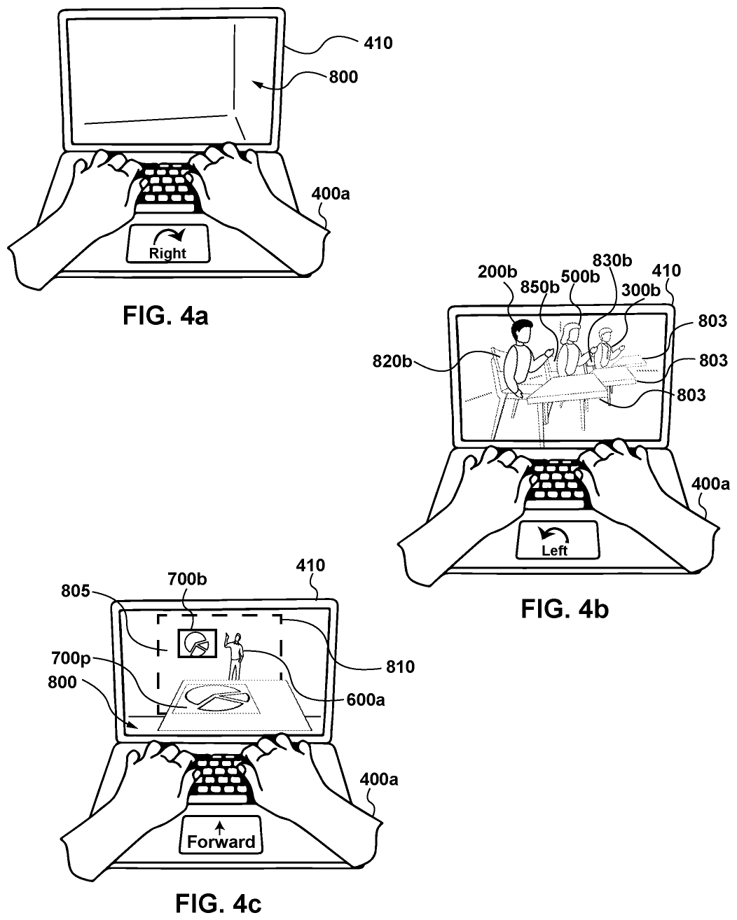

The individual participant data 20, the environmental data 30, the presenter data 40, and/or the agglomerated data 50 can be processed by the processor 120 in conjunction with the SR generator 146 for converting the information to a corresponding asset position or orientation within the virtual reality environment. For example, the environment data 30 is transmitted to the remote participant device (e.g. 200, 300, 400, 500) for rendering on the viewing device (e.g. 210, 310, 410, 510), allowing the user of the viewing device 200 to view and interact with the environment via real world motion or manipulation of the remote participant device (e.g. 200, 300, 400, 500). The movement of the device can correspond to the environment changes rendered on the device in such a way that movement of the device allows for new viewing perspectives of the environment with each movement. The effect is that the device functions as a window into the virtual environment with each new location of the window showing a different aspect, perspective, or viewing direction of the environment. This may be performed using any now or hereafter known methods and systems such as using coordinate system translation. For example, the participant 200a can direct the view from participant 200s's perspective to other participants as shown in FIG. 3A and FIG. 3B. The participant 200a can also direct the view from participant 200s's perspective to the feed from the presenter incorporated in the simulated reality environment as shown in FIG. 3C. FIGS. 4A-6C show a similar manipulation of the perspectives of the virtual reality environment for other participants (described below).

In accordance with various embodiments, the individual participant data 20 can be processed by the processor 120 operating the SR generator 146 for converting the information to the environmental data 30. The environmental data 30 includes asset position and/or orientation within the virtual reality environment. The assets can include other avatars corresponding to other remote participants or the presenter stream. The environmental data 30 can then be transmitted to another device (e.g. 300) for rendering thereon and placing the asset in a new position or orientation within the virtual reality environment of that participant (e.g., 300a) in response to movement of the device 200. Similar changes in the asset (depicted as avatar 200b) would be viewable in the immersive device 310 based on changes to the position of the viewing device 210. Likewise, similar changes in the asset (e.g. depicted as avatar 200b) would be viewable in another device (e.g. 510) based on changes to the position of the viewing device 210.

In accordance with various embodiments, the other devices (e.g. 310, 410, 510, etc.) can also collect position/orientation data and transmit it as remote participant data 20. The remote participant data 20 can be processed by the processor 120 operating the virtual reality environment generation system 146 for converting the transmitted data 40 to a corresponding other asset position which can then be sent to a remote participant device (e.g. 200) as part of the environment data 30. In this way, updates and changes to other assets (e.g. 300b, 400b, 500b shown in FIGS. 3A-6B) can be tied into movements of the corresponding viewing device such that the movements of the corresponding viewing device is updated to the various other devices by updated and changed renderings of the assets in the environment generation system 146 and then displayed on the various remote participant devices. As discussed above, changes in the asset (e.g. depicted as avatar 200b) would also be viewable by the presenter 600a via the display 620.

As indicated above, the server 100 can include one or more processing elements 120. The processor 120 refers to one or more devices within the computing device that are configurable to perform computations via machine-readable instructions stored within the memory components 140. The processor 120 can include one or more microprocessors (CPUs), one or more graphics processing units (GPUs), and one or more digital signal processors (DSPs). In addition, the processor 120 can include any of a variety of application-specific circuitry developed to accelerate the virtual reality system 100. The one or more processing elements may be substantially any electronic device capable of processing, receiving, and/or transmitting instructions. For example, the processing element may be a microprocessor or a microcomputer. Additionally, it should be noted that the processing element may include more than one processing member. For example, a first processing element may control a first set of components of the computing device and a second processing element may control a second set of components of the computing device, where the first and second processing elements may or may not be in communication with each other, e.g., a graphics processor and a central processing unit which may be used to execute instructions in parallel and/or sequentially.

In accordance with various embodiments, one or more memory components 140 are configured to store software suitable to operate the server 100. The memory stores electronic data that may be utilized by the computing device. For example, the memory may store electrical data or content, such as audio files, video files, document files, and so on, corresponding to various applications. The memory may be, for example, non-volatile storage, a magnetic storage medium, optical storage medium, magneto-optical storage medium, read only memory, random access memory, erasable programmable memory, flash memory, or a combination of one or more types of memory components. Specifically, the software stored in the memory launches immersive environments via a virtual reality environment generator 146 within the server 100. The SR generator 146 is configured to render virtual reality environments suitable to be communicated to the participant displays (e.g. 210, 310, 410, 510) and/or the presenter display 620.

In order to render the virtual reality environment, the SR generator 146 may pull the source data 141 from memory and instantiates it in a suitably related environment provided by the generator 146 and or environmental attributes 142. Examples of environmental attribute 142 may include, without limitation, attributes corresponding to the virtual reality instance such as, for a classroom virtual reality instance, position of chairs and desks, a podium, or the like. The SR generator 146 also pulls asset data 144 (i.e., corresponding to the remote participant and/or presenter) for positioning into the environment of the virtual reality instance. As discussed above, the asset data may be supplemented by information received from sensors to determine locations, movement, and updated locations. In various embodiments, the conversion engine 145 maps the asset data 144 into the environment based on input from the various participant devices (e.g. device 200), the related sensors (e.g. sensor 225), and/or a defined layout of the virtual reality environment. For example, the presenter stream can be defined as an asset and be embedded in a specific location in the virtual reality environment corresponding to a presentation area, screen, wall, or other suitable location conducive to the viewing and/or understanding by the remote participants. The conversion engine 145 can also modify the position/orientation information to be utilized to display and manipulate the asset in the virtual reality environment to a more natural display for the participant or presenter.

The generator 146 may be configured to provide instructions to the processor 120 in order to display the environment in the proper format such that the environment is presented on the viewing device (e.g. 200, 300) and the asset is in the proper orientation to the viewer to improve the viewer experience. The generator 146 can also access information from the asset data 144, as discussed above, in order to locate the asset in the environment and/or other assets in the environment with respect to one another. The asset data 144 can receive communications from the sensors 225 via the network communications 180 providing information, characteristics, and various attributes about the participant, the participant's position, actions, controller inputs, etc., in order to provide the system sufficient information to form, manipulate, and render the assets within the environment. The same applies for the avatars of other users. As discussed herein, in various embodiments, the assets can include avatars representative of the various remote participants. The avatars may also be representative of the participants' real-world position or orientation.

In accordance with various embodiments, the computing system 100 includes an asset blending module 143. After capture of a presenter stream, secondary processing of the stream occurs, allowing the stream to be embedded into a virtual reality environment as a stream asset for viewing by remote participants. In various embodiments the asset blending module embeds the stream, forming a separation in the virtual reality environment so that participants in the virtual reality region via their avatars can see across the partition/streaming asset to view a real environment in which the presenter 600a is providing a presentation in real-time or near real-time. In other embodiments, the steam asset can be so stripped down it appears as merely an asset as opposed to a partition. For example, the stream can be processed such that only the presenter is embedded in the virtual reality environment without any real environment surroundings around the presenter. In some embodiments, the blending module can embed the asset strategically. For example, the stream asset can be positioned such that it appears to form or is being performed on a virtual stage.

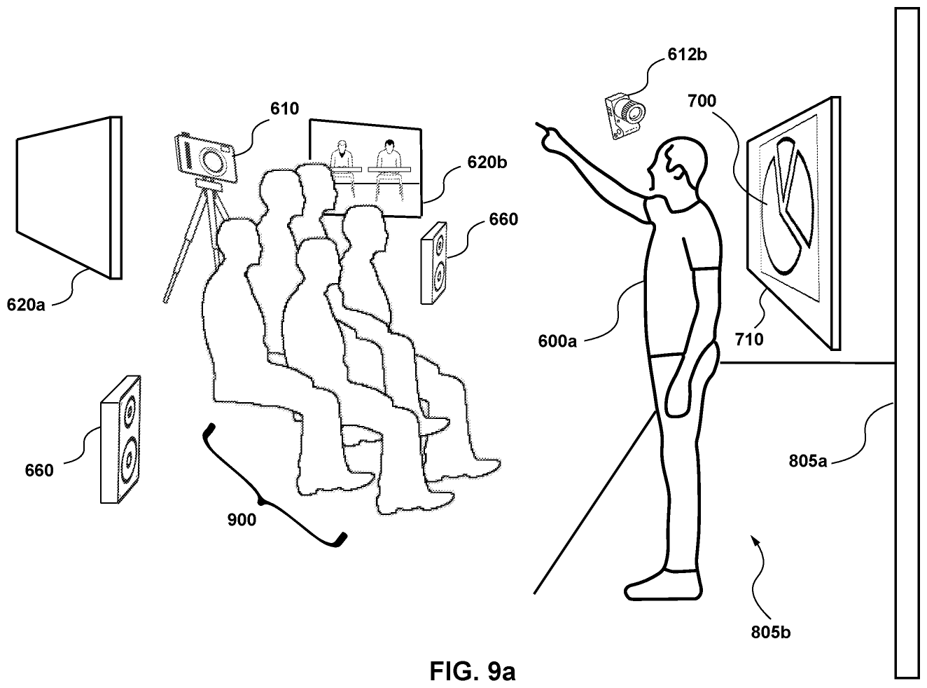

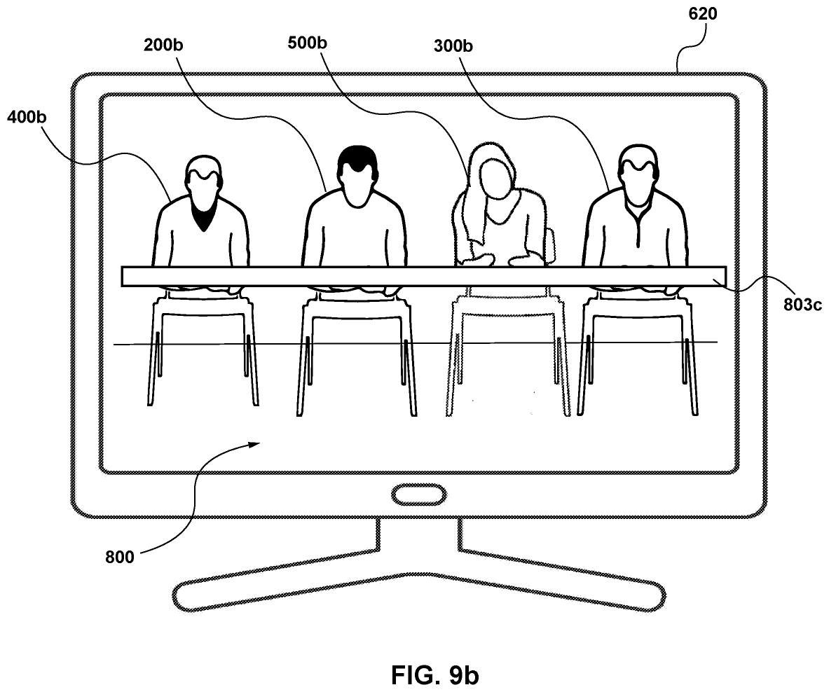

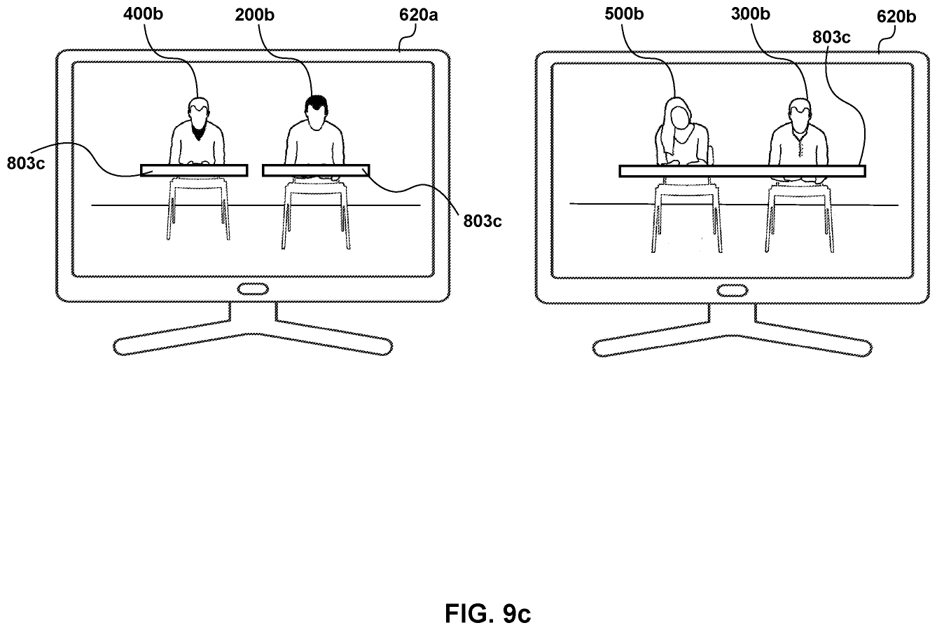

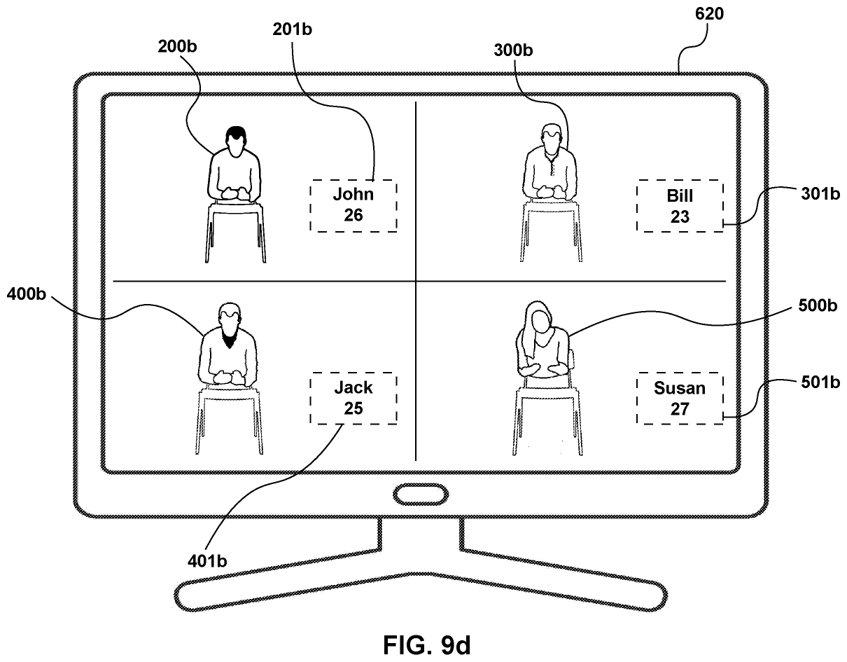

In accordance with various embodiments, the computing system 100 includes an aggregate feed module 149. The aggregate feed module 149 packages all of the different remote participant feeds 20 for display on the presenters' displays 620. The aggregate feed module can prepare the feeds for display in a variety of different ways that are discussed in more detail below with regards to FIGS. 9B-9D.

In accordance with various embodiments, the computing system 100 includes one or more network communication connections 180. The network communication connections 180 are configured to communicate with other remote systems. The networking/communication interface receives and transmits data to and from the computing device. The networking/communication interface may transmit and send data to the network, other computing devices, or the like. For example, the networking/communication interface may transmit data to and from other computing devices through the network which may be a wireless network (e.g., Wi-Fi, Bluetooth, cellular network, etc.) or a wired network (Ethernet), or a combination thereof. In particular, the network may be substantially any type of communication pathway between two or more computing devices. For example, the network may be wireless, wired, or a combination thereof. Some examples of the network include cellular data, Wi-Fi, Ethernet, Internet, Bluetooth, closed-loop network, and so on. The type of network may include combinations of networking types and may be as varied as desired. In some embodiments, the network communications may be used to access various aspects of the immersive platform from the cloud, another device, or a dedicated server. In a number of embodiments, the computing system 100 uses a driver memory to operate the various peripheral devices including the operation hardware/power supply 170, and/or the network communications 180.

In accordance with various embodiments, a user 200a utilizing a non-immersive device 210 interacts via the presentation interface and immersion platform 10 with an additional user or users, such as one or more of user 300a, user 400a, user 500a, and/or other users. Preferably, the non-immersive device is a handheld device 210 and the additional user 300a utilizes an immersive device 310. Alternatively or additionally, the additional user may be user 400a that utilizes a semi movable immersive device 410 such as a laptop computer. Alternatively or additionally, the additional user may be user 500a that utilizes an operable augmented reality device 510. In such embodiments, the virtual reality system 10 can be generated entirely as an augmented reality system. In other embodiments, the virtual reality system 10 can be generated entirely as a virtual reality system. In yet other embodiments, the virtual reality system 10 can be generated as a hybrid virtual reality and augmented reality system.

While it is appreciated that the users may be local to one another, it is also understood that one or more of the users may be separated from the others, and may be located in different locations, environments, etc. In accordance with various embodiments, all of the users may be separated from one another such that the interaction between users is limited to the virtual reality environment. The figure is merely shown with the illusion of locality in order to display a relative relationship between the users of the system that can then be recreated by the virtual reality system allowing the users to experience one another as though they are interacting locally.

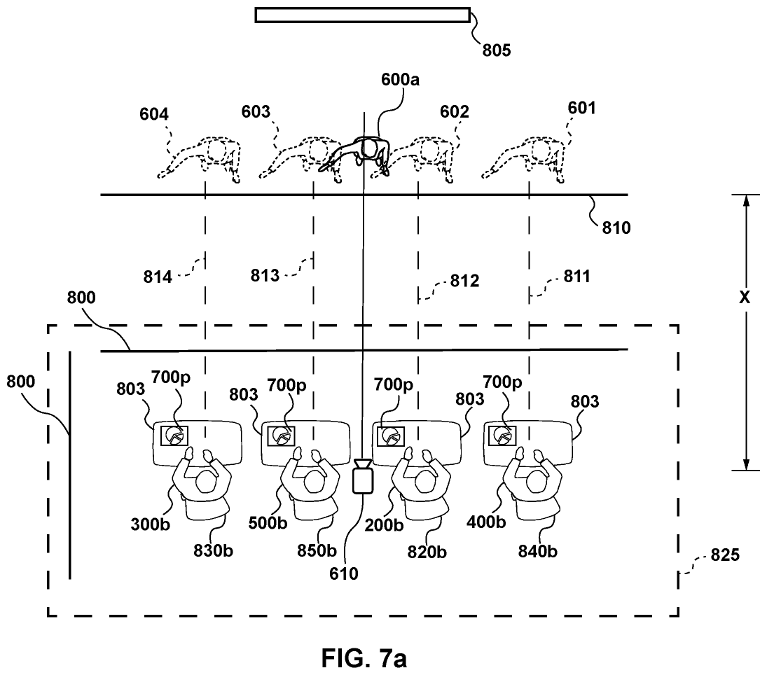

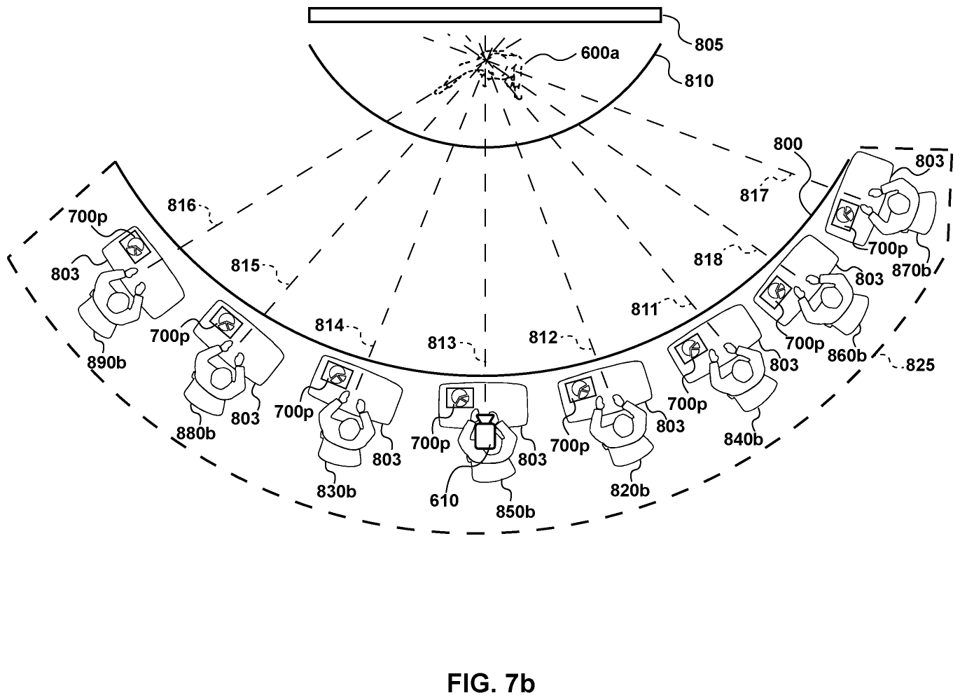

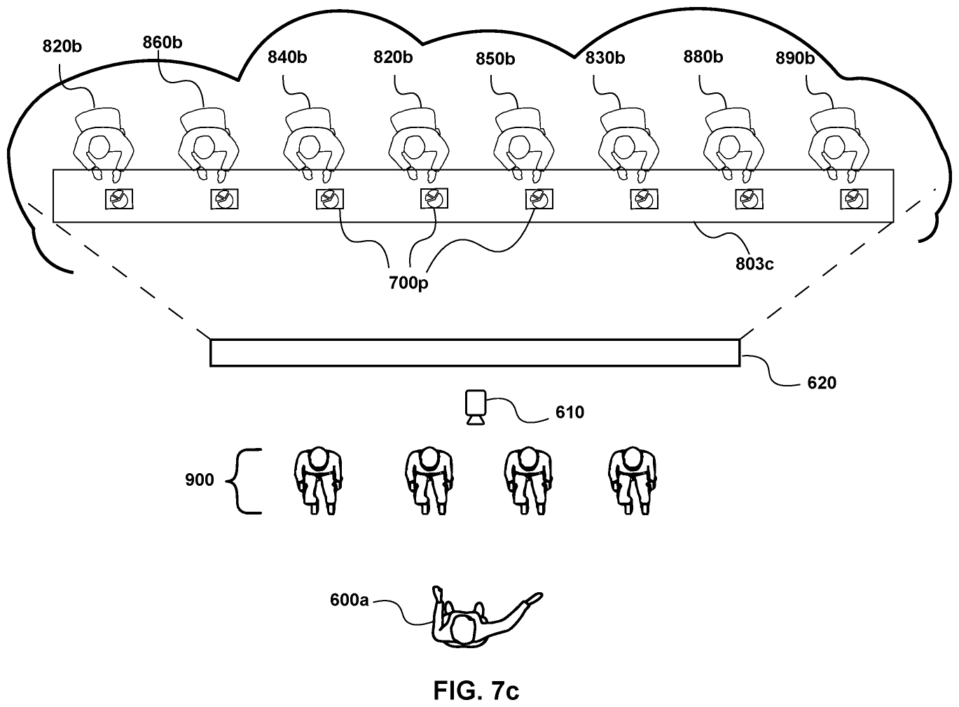

In accordance with various embodiments, the presentation interface and immersion platform 10 for generating a virtual reality environment allows for user interaction between the different user devices. For example, for a virtual reality instance including chairs for remote participants arranged with respect to each other as shown in FIG. 7A, FIG. 3A illustrates a virtual reality environment generated for user 200a when device 200 directs the non-immersive device 210 in direction A (shown as to the right of 200a). By way of example, the presentation interface and immersion platform 10 returns renderings of assets in the first portion of the environment, such as avatars of user 400a for display on device 200a as shown in FIG. 3A. As shown in FIG. 3B, user 200a directs the handheld device 210 in direction B (shown as to the left of 200a in the virtual reality instance of FIG. 7A) allowing input from the generator 146 to display a second portion of the virtual reality environment. By way of example, the second portion of the virtual reality environment includes rendered assets, such as avatars of user 500a and 300a for display on device 200a as shown in FIG. 3B. Thus, motion of the non-immersive device 210 allows for viewing of a different portion and different assets within the virtual reality environment.

In accordance with various embodiments, the remote participant devices (e.g. 200, 300, 400, 500) may include one or more sensors (e.g. 240, 230). The sensors acquire information suitable for establishing at least one of a position or orientation. In accordance with various embodiments, the sensors (e.g. 225) include one or more of accelerometer (e.g. 240) or gyroscopic (e.g. 230) sensors. In various embodiments, accelerometer or gyroscopic sensors can form an Inertial Measurement Unit (IMU), which acquires data for determining position or orientation of the viewing device. In other embodiments, visual data via the camera or data acquired via global positioning sensors (GPS), Wi-Fi data, or magnetometers can also be used to determine position and or orientation of the viewing device. Changes in a viewing device's position can be calculated based on the device's sensors. Instances of the virtual reality environment that are run on the remote participant devices can send position and orientation data based upon the location and orientation of the device to another device or the central system 100. The specific means by which such data is gathered on a given class of device or operating system (OS) differ. These differences are however contemplated herein based on the application that one of ordinary skill in the art can apply according to the disclosure provided herein. In accordance with various embodiments, the sensor or sensors gather the most reliable location and/or orientation data from the remote participant device (e.g. 200). The location and/or orientation data is then normalized before sending out. The normalization occurs when the application driving the device makes remote procedure calls to the server, which will result in appropriate messages being transmitted to all participating devices. This can be either an application running on a mobile device (phone, tablet, laptop, Oculus Rift, etc.), or an application running on the computer that is driving a tethered Head Mounted Display (HTC Rift, Oculus Go, Oculus Quest, or Windows Mixed Reality). The normalization follows a process for passing position, orientation, scale, and/or voice information in a VR multi-user environment. As discussed herein, the normalization occurs across the various types of devices, paradigms, and/or platforms allowing each to interpret the message from the server appropriately. This allows the data sent to the system 100, other viewing devices 300, or to the presenter system 600 (more specifically the viewing device 620) to accurately reflect the remote participant's position, scale, orientation, and/or other suitable display characteristic of the transmitting device 200, with respect to the virtual environment reference frame (i.e., normalization), in real-time or near real-time.

The above disclosed embodiments allow for exchanges between different platforms of devices, e.g. non-immersive and immersive devices, with movement of either type of platform updating the rendered environment shown on the other platforms to depict that movement as asset movement within the virtual environment. In accordance with various embodiments, the assets are avatars representing the users of the devices. In this way, movement of the device user shows up as movement of the avatar within the virtual reality environment regardless of whether the user is using an immersive device or a non-immersive device. Movement within a virtual reality environment is then achieved by non-immersive devices via movement of the device itself. In some embodiments, this may be limited to orientation of the asset via movement of the device. Here, orientation refers to pitch, yaw, and roll of the device corresponding to pitch, yaw, and roll of the asset. In some embodiments, this may be limited to translational movement of the device. Here, translational movement refers to forward, back, and up/down of the device corresponding to forward, back, and up/down of the asset. In some embodiments, all six degrees of freedom may correspond between movement of the device and movement of the asset. In accordance with various embodiments, the correlation between movement of the device and movement of the asset may be modified to allow for more realistic movement of the asset.

FIG. 3A, FIGS. 3B, and 3C illustrate an example of a participant device platforms 200 displaying a simulated reality environment 800 (shown in FIG. 7A) around a live feed or streaming asset 810 (corresponding to a presenter 600a) contained therein in accordance with various embodiments disclosed herein. FIG. 3A illustrates the display 210 depicting a view of the virtual environment 800 if the avatar 200b was positioned in seat 820b (shown in FIG. 7A) generally facing the presenter 600a but looking to the avatar's right. In this orientation the participant device 200 shows avatar 400b in seat 840b. FIG. 3B illustrates the display 210 depicting a view of the virtual environment 800 if the avatar 200b was positioned in seat 820b (shown in FIG. 7A) generally facing the presenter 600a but looking to the avatar's left. In this orientation the participant device 200 shows seated avatars 500b and 300b in seats 850b and 830b respectively. FIG. 3C illustrates the display 210 depicting a view of the virtual environment 800 if the avatar 200b was positioned in seat 820b (shown in FIG. 7A) generally facing the presenter 600a. In this orientation the participant device 200 shows the presenter 600a. In some embodiments, as discussed above, a secondary asset 700b can be embedded in the display 210. Here the secondary asset 700b is shown adjacent the presenter 600a as a separate digital image projected in the virtual reality environment 800 providing a clearer image of the presenter's original visual aid 710 shown in FIG. 7A. As shown, either one or both of the presenter 600a and the secondary asset 700b are embedded in the virtual reality environment 800 as part of a streamed asset 810. Here, the streamed asset appears as a partition in the virtual reality environment 800 that divides a portion that is clearly virtual and a portion of the environment that is a video representation of a real environment including at least a portion of the presenter 600a. In various embodiments, the real environment shown in the streamed asset 810 includes a portion of the real environment 805 (e.g. background 805a, stage 805b) around the presenter 600a.

In accordance with various embodiments, a secondary asset can be displayed on a virtual asset (e.g. desk 803) in this way the secondary asset can be transmitted separately from the streaming asset and displayed in the virtual environment separately from the streaming asset that may show a real world view. For example, the virtual region 825 may have an environmental asset 803 such as a desk for each participant controlled asset (e.g. avatar) or for each group. The secondary asset (e.g. presentation 700p) can be displayed adjacent to the participant controlled asset on the environmental asset 803. This separation of the secondary asset from the streaming asset may occur when a higher resolution camera (e.g. camera 612 in FIG. 9A) is used to capture the asset or in situations where the secondary asset is natively digital such as in a power point presentation, on a smart board, or visual aids applied to some other type of computing device Examples, of this are shown throughout FIGS. 2-9.

FIG. 4A, FIGS. 4B, and 4C illustrate an example of a participant device platform 400 displaying a simulated reality environment 800 around a live feed asset 810 contained therein in accordance with various embodiments disclosed herein. FIG. 4A illustrates the display 410 depicting a view of the virtual environment 800 if the avatar 400b was positioned in seat 840b (shown in FIG. 7A) generally facing the presenter but looking to the avatar's right. In this orientation, the display 410 of the participant device 400 shows only the virtual reality environment around the avatar since in this example the other avatars are all positioned to the left of avatar 400b (as shown in FIG. 7A). In other embodiments, instead of showing the virtual reality environment, the avatars could be surrounded by displays of the real environment on the exterior of the navigable virtual region. FIG. 4B illustrates the display 410 depicting a view of the virtual environment 800 if the avatar 400b was positioned in seat 840b (shown in FIG. 7A) generally facing the presenter 600a but looking to the avatar's left. In this orientation, the display 410 shown on the participant's device 400 shows avatars 500b, 300b, and 200b in seats 850b, 830b, and 820b respectively. FIG. 4C illustrates the display 410 depicting a view of the virtual environment 800 if the avatar 400b was positioned in seat 840b (shown in FIG. 7A) generally facing the presenter 600a. In this orientation the display 410 of the participant device 400 shows the presenter 600a. In some embodiments, as discussed above, a secondary asset 700b can be an embedded virtual environment as part of the streamed asset 810. Here, the secondary asset 700b is shown adjacent the presenter 600a as a separate digital image projected in the virtual reality environment 800, providing a clearer image of the presenter's original visual aid 710 shown in FIG. 7A. As shown, either one or both of the presenter 600a and the secondary asset 700b are embedded in the virtual reality environment 800 as part of a streamed asset 810. Here, the streamed asset appears as a partition in the virtual reality environment 800 that divides a portion that is clearly virtual and a portion of the environment that is a video representation of a real environment including at least a portion of the presenter 600a. In various embodiments, the real environment shown in the streamed asset 810 includes a portion of the real environment 805 (e.g. background 805a, stage 805b, etc.) around the presenter 600a.

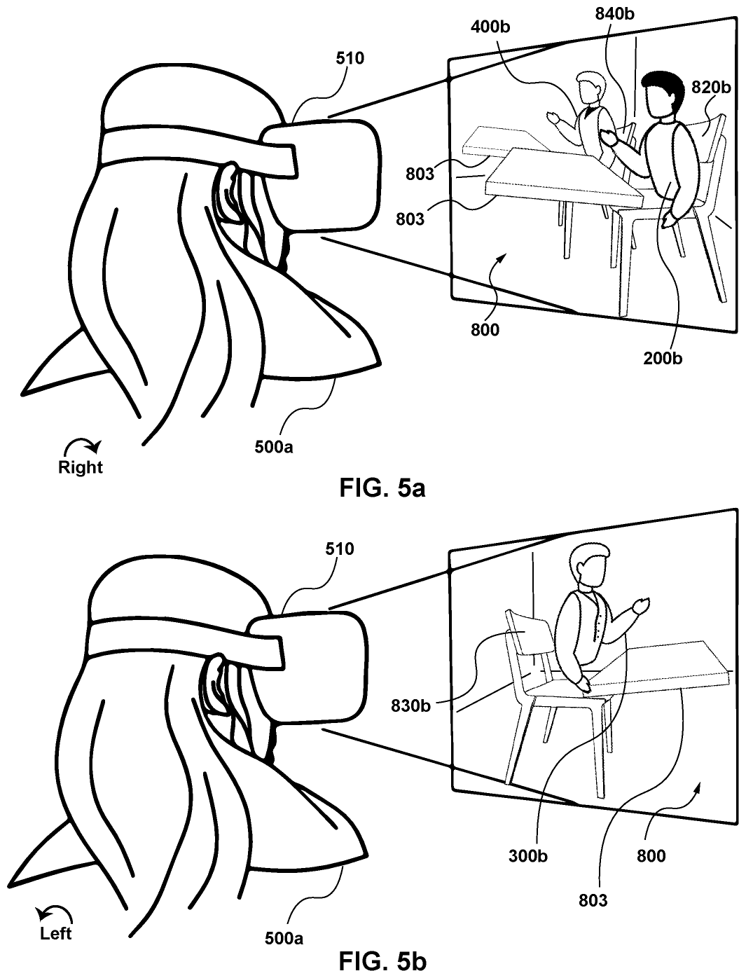

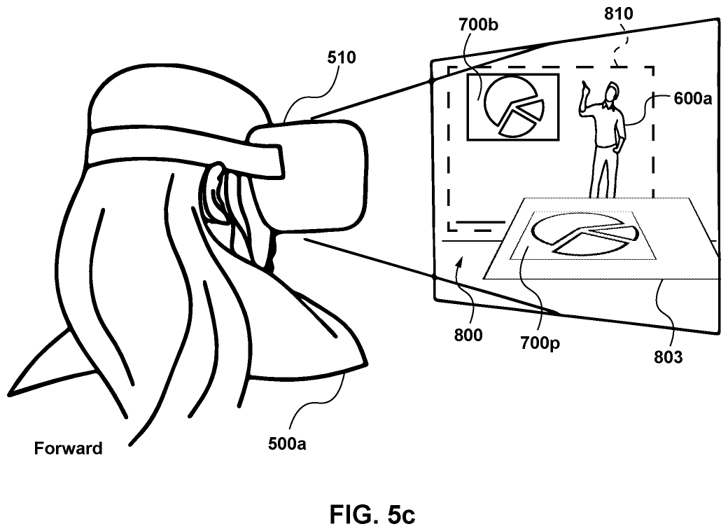

FIG. 5A, FIGS. 5B, and 5C illustrate an example of a participant device platform 500 displaying a simulated reality environment 800 around a live feed asset 810 contained therein in accordance with various embodiments disclosed herein. FIG. 5A illustrates the display 510 depicting a view of the virtual environment 800 if the avatar 500b was positioned in seat 850b (shown in FIG. 7A) generally facing the presenter but looking to the avatar's right. In this orientation the display 510 of the participant device 500 shows avatars 200b and 400b (as shown in FIG. 7A). FIG. 5B illustrates the display 510 depicting a view of the virtual environment 800 if the avatar 500b was positioned in seat 850b (shown in FIG. 7A) generally facing the presenter 600a but looking to the avatar's left. In this orientation the display 510 shown on the participant's device 500 shows avatar 300b in seat 830b. FIG. 5C illustrates the display 510 depicting a view of the virtual environment 800 if the avatar 500b was positioned in seat 850b (shown in FIG. 7A) generally facing the presenter 600a. In this orientation the display 510 of the participant device 500 shows the presenter 600a. In some embodiments, as discussed above, a secondary asset 700b can be embedded in the virtual environment as part of the streamed asset 810. Here, the secondary asset 700b is shown adjacent the presenter 600a as a separate digital image projected in the virtual reality environment 800, providing a clearer image of the presenter's original visual aid 710 shown in FIG. 7A. As shown, either one or both of the presenter 600a and the secondary asset 700b are embedded in the virtual reality environment 800 as part of a streamed asset 810. Here, the streamed asset appears as a partition in the virtual reality environment 800 that divides a portion that is clearly virtual and a portion of the environment that is a video representation of a real environment including at least a portion of the presenter 600a. In various embodiments, the real environment shown in the streamed asset 810 includes a portion of the real environment 805 (e.g. background 805a, stage 805b, etc.) around the presenter 600a.

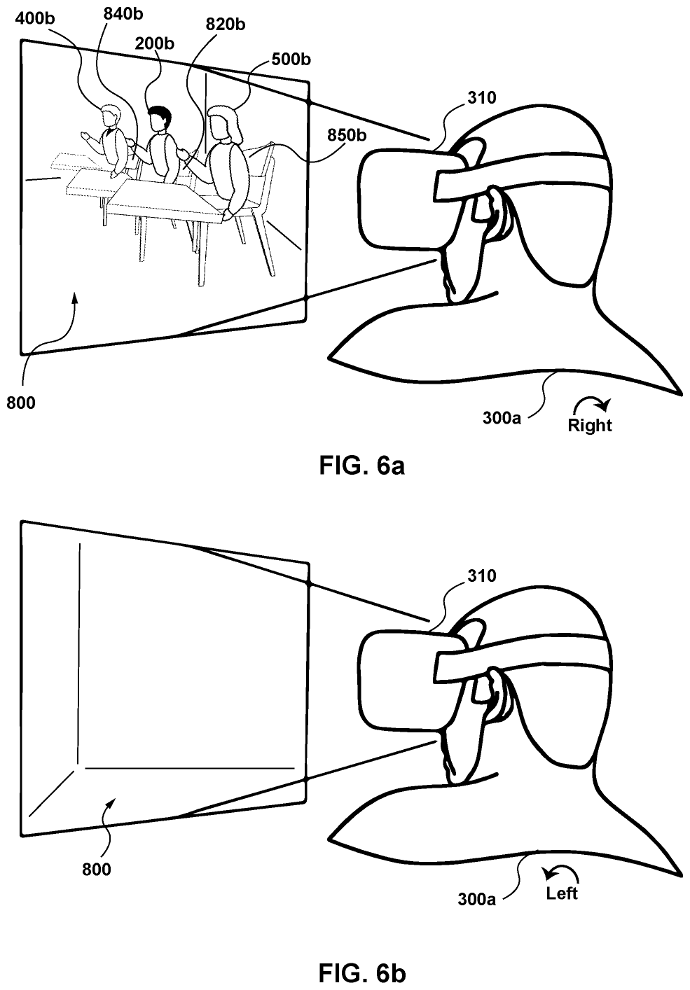

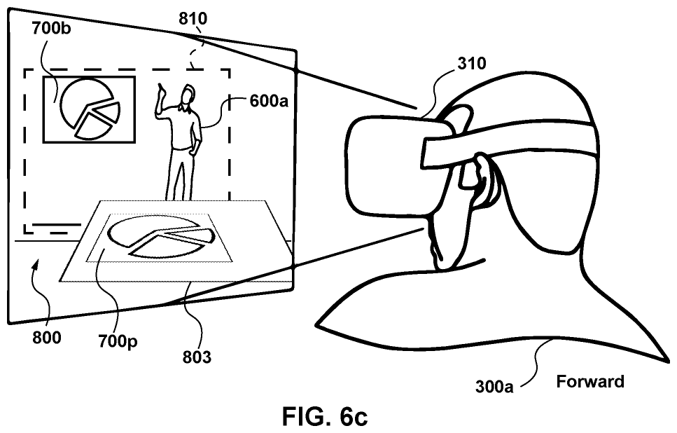

FIG. 6A, FIGS. 6B, and 6C illustrate an example of a participant device platform 300 displaying a simulated reality environment 800 around a live feed asset 810 contained therein in accordance with various embodiments disclosed herein. FIG. 6A illustrates the display 310 depicting a view of the virtual environment 800 if the avatar 300b was positioned in seat 830b (shown in FIG. 7A) generally facing the presenter but looking to the avatar's right. In this orientation, the display 310 shown on the participant's device 300 shows avatars 500b, 400b, and 200b in seats 850b, 840b, and 820b respectively. FIG. 6B illustrates the display 310 depicting a view of the virtual environment 800 if the avatar 300b was positioned in seat 830b (shown in FIG. 7A) generally facing the presenter 600a but looking to the avatar's left. In this orientation, the display 310 of the participant device 300 shows only the virtual reality environment around the avatar since in this example the other avatars are all positioned to the right of avatar 300b (as shown in FIG. 7A). In other embodiments, instead of showing the virtual reality environment, the avatars could be surrounded by displays of the real environment on the exterior of the navigable virtual region. FIG. 6C illustrates the display 310 depicting a view of the virtual environment 800 if the avatar 300b was positioned in seat 830b (shown in FIG. 7A) generally facing the presenter 600a. In this orientation the display 310 of the participant device 300 shows the presenter 600a. In some embodiments, as discussed above, a secondary asset 700b can be embedded in the virtual environment as part of the streamed asset 810. Here, the secondary asset 700b is shown adjacent the presenter 600a as a separate digital image projected in the virtual reality environment 800, providing a clearer image of the presenter's original visual aid 710 shown in FIG. 7A. As shown, either one or both of the presenter 600a and the secondary asset 700b are embedded in the virtual reality environment 800 as part of a streamed asset 810. Here, the streamed asset appears as a partition in the virtual reality environment 800 that divides a portion that is clearly virtual and a portion of the environment that is a video representation of a real environment including at least a portion of the presenter 600a. In various embodiments, the real environment shown in the streamed asset 810 includes a portion of the real environment 805 (e.g. background 805a, stage 805b, etc.) around the presenter 600a.

In accordance with various embodiments, the perceived orientation of the avatars relative to one another can vary. In the embodiments discussed above shown in FIGS. 3-6, the avatars all maintain a relative position to one another in the virtual reality environment. For example, when two avatars are next to one another, each avatar perceives the other in consistent relative positions, with one avatar on the left and the other on the right. However, in other embodiments, each avatar can be positioned such that they have the perspective in the virtual reality environment that they are each at the same location but perceive the other avatars at different locations. For example, all of the avatars could perceive themselves to be at seat 820b. In such an embodiment, the other avatars would not all perceive each other at the same location but instead could perceive each at randomized locations. This changes the way the avatars perceive their relative movement in the virtual reality environment, but it allows each avatar in the small group to enjoy the same centered feel in the group of avatars, such as each avatar gets to be positioned at the center seat of the presentation.

FIGS. 7A and 7B show overhead diagrams of a presentation environment (i.e., a virtual reality instance environment) as it would be perceived by the remote participants and/or the presenter. The examples are shown from above to illustrate the perceived relative relationship of the participants (e.g. 200a, 300a, 400a, 500a) along with their perceived relative relationship to the presenter 600a. FIG. 7A depicts a linear arrangement of example viewing locations of the avatars (e.g. 200b, 300b, 400b, 500b). As illustrated, each avatar experiences the presenter 600a from the perspective of the capture device 610. Notably, the capture device is illustrated here to depict a relationship between the capture device and the presenter but the capture device is not a part of nor can it be viewed in the virtual environment. Instead, the capture device defines a perceived distance between the participant asset and the real-world environment 805 that can be experienced by viewing the streamed asset 810 in the virtual environment. In various embodiments, each virtual reality environment can have a virtual region 825 and a real world portion defined by the streamed asset 810. In various embodiments the two regions can be separated such that the participant controlled assets (e.g. avatars) can only move around in, interact with, or otherwise engage with the virtual region 825. In various embodiments, the virtual region includes multiple assets (e.g. participant controlled assets or environmental assets). Examples, of environmental assets are shown and can include items like chairs, tables, walls, controls, etc. The participant controlled asset is located relative to the other participant controlled assets in different positions in the virtual region 825. In various embodiments, the real world images, streams, or other visual aspects representative of actual events or places are located outside of the virtual region.

In accordance with various embodiments, despite the relative positional difference, each avatar views the streamed asset 810 as it is captured by the capture device. As shown in this example, this is done head on. Thus, each avatar (e.g. 200b, 300b, 400b, 500b) can view the presentation head on with the perception that the presenter is directly in front of each avatar. This perception is illustrated in FIG. 7A with a viewing direction line 811, 812, 813, 814 respectively positioned relative to avatars 400b, 200b, 500b, 300b. This perception would locate the presenter as 601, 602, 603, and 604 directly in front of the respective avatars. Each avatar would be positioned relative to the presenter 600a and the associated streamed asset 810 (e.g. the video stream of the presenter and the surroundings 805). In this way the streaming asset is displayed in the virtual reality environment with respect to each avatar corresponding to individual remote participants not with respect to the space. Each avatar would perceive that the center (e.g. presenter) of the recorded real world environment is directly in front of them even if they are positioned on outside positions (e.g. 840b or 830b) relative to the other avatars. Even with each avatar looking directly ahead, in small enough groups with the presenter positioned at a perceived distance that is far enough from the group of avatars, it will still appear that each avatar is looking in the direction of a single presenter centered on the group of avatars. However, if the group of avatars is too large or the group is too close to the presenter, then each avatar will have the perception that the other avatars are not looking at the presenter. As such, a preferred embodiment maintains the illusion that even with each avatar looking directly ahead, they are all looking at the presenter—i.e., the streamed asset corresponding to the presenter may be positioned relative to the avatar. This is done by controlling the perceived distance X between an avatar and the presenter relative to the number of avatars across the virtual environment. The perceived distance X can also be changed by scaling the size of the streamed asset 810. The number of avatars can be controlled by having separate instances of the presentation embedded into virtual environments with a limited number of avatars. Although it should be appreciated that the perception that all avatars are looking at the presenter can be maintained with groups larger than four avatars.

In another embodiment, the arrangement of the avatars relative to one another can allow for the perception that all avatars are looking at the presenter to be maintained despite a significantly larger number of avatars. For example, FIG. 7B depicts an arced arrangement of example viewing locations of the avatars (e.g. 820b, 830b, 840b, 850b). This arrangement includes an additional number of viewing locations 860b, 870b, 880b, and 890b. As illustrated, each avatar experiences the presenter 600a from the perspective of the capture device 610. Notably, the capture device is illustrated here to depict a relationship between the capture device and the presenter but the capture device is not a part of nor can it be viewed in the virtual environment. Instead, the capture device defines a perceived distance between the participant asset and the real-world environment 805 that can be experienced by viewing the streamed asset 810 in the virtual environment. However, in various embodiments, each avatar is located relative to the other avatars in different positions in the virtual reality region 825. Despite these relative positional differences, each avatar views the streamed asset 810 as it was captured by the capture device. As shown in this example, this is done head on. Thus each avatar can view the presentation head on with the perception that the presenter is directly in front of each avatar. The perception illustrated in FIG. 7B includes viewing direction lines 811, 812, 813, 814, 815, 816, 817, and 818 respectively positioned relative to the locations 820b, 830b, 840b, 850b, 860b, 870b, and 880b. In contrast to the example above, these viewing direction lines all converge on the presenter 600a. Thus, despite the perceived difference in location and regardless of the number of avatars, if all of the viewing directions converge then each avatar will perceive that the other avatars are looking at the same presenter in the same direction.

It should also be pointed out that FIGS. 7A and 7B show virtual chairs (E.g. 820b, 830b, 840b, and 850b). These chairs can be useable assets within the region or additionally or alternatively the chairs can merely represent relative locations within the virtual region 825. While virtual assets of chairs can be included, in some embodiments no virtual asset is included but in others different virtual assets such as tables, desks, lecterns, etc. can be included.

The relation between the presenter and the participant as discussed above with regards to FIGS. 7A and 7B allows the presenter to engage with (e.g. appear to look directly at) each and every participant controlled asset (e.g. avatar) and in turn the participant directly. This gives the impression that each participant is receiving individualized attention from the presentation, thus giving them an individualized experience.

In accordance with various embodiments, the participant controlled asset (e.g. 200b, 300b, 400b, 500b) can be displayed on the presenter's viewing device 620. These same assets can be displayed on the participants viewing devices (e.g. 200, 300, 400, 500). The perception of the relationships can be different between these viewing devices. For example, the first participant controlled asset and the second participant controlled asset experience the virtual reality environment as perceived through the display on the participant viewing device according to the relationships shown in FIG. 7B. Here the relative viewing locations of each of the participant controlled assets would be based on an arced shape around the streamed asset. Participant viewing devices could all perceive this relationship from various points on the arc. Additionally, different assets may be present. For example, each location in FIG. 7B includes individual tables 803 as assets populating the virtual region 825. FIG. 7C illustrates a perceived environment of the presenter 600a. Here, the presenter sees local participants 900, the capture device 610 and the viewing device 620. In the viewing device 620, the presenter 600a sees a linear relationship of all of the assets instead of the arced relationship that the participant controlled assets perceive. The nature of the assets can also change. As shown in FIG. 7C the asset 803c is not individual tables but a single long table 803c. the long table can display all of the secondary streamed assets 700p adjacent to each of the participant controlled assets. Thus, the first participant controlled asset and the second participant controlled asset are perceived to experience the virtual reality environment differently through the display on the presenter viewing device than the display on the participant devices. The virtual reality system 100 and the generator therein can construct the different relationships and then transmit them differently depending on whether the transmission is to the participant or the presenter.

In some embodiments, the participant controlled asset (e.g. 200b, 300b, 400b, 500b) displayed on the presenter's viewing device 620 is displayed in a virtual reality environment from the perspective of the location assigned to the streaming asset within the virtual reality environment. Specifically, the participant controlled asset is displayed on the present's viewing device from the perspective of a viewer located with respect to the streaming asset's location in the virtual reality environment (for example, behind the streaming asset and looking at the participant controlled asset).

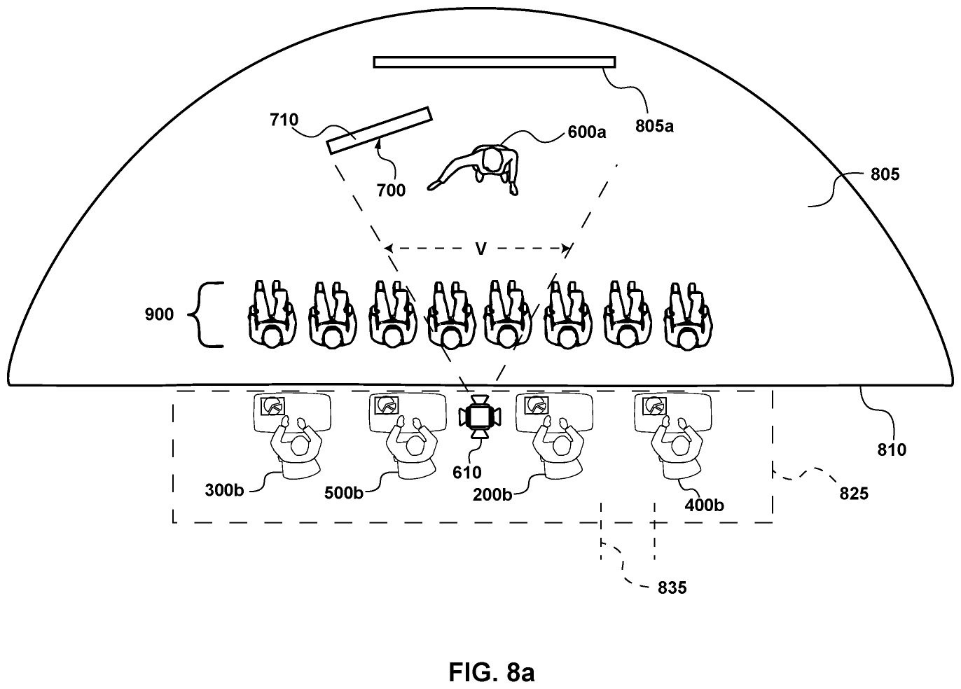

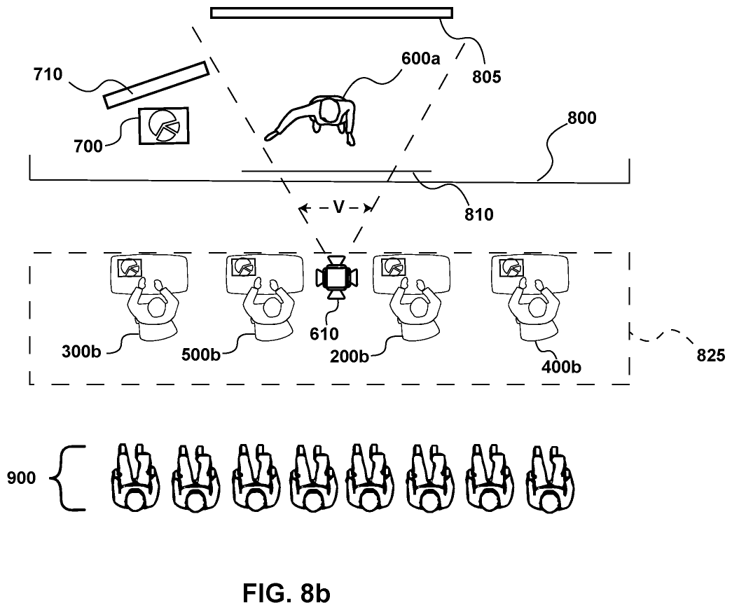

In accordance with various embodiments, the capture system 600 can be configured to capture a wide range of the real environment and include this wide range as a part of the streamed asset. For example, local participants located with the presenter in the real world can be included in the captured feed. FIGS. 8A and 8B illustrate schematic overhead diagrams of an example of a presentation blended with a simulated reality environment. Like FIGS. 7A and 7B, the illustrations represent perceptions of the virtual world to be the participants. In FIG. 8A a row of local participants 900 are positioned in front of the remote participant virtual region 825. This can be captured and presented this way by locating the capture device 610 behind the local participants. As shown in the image, the capture device has a viewable range V. With too narrow of a viewable range, only a couple of local participants are included. With too large of a viewable range the partition between the remote users and the local users is lost. In some embodiments, the capture device is stereoscopic. In some embodiments, the capture device is a 180 degree camera suitable to capture the local participants 900. In some embodiments, the capture device is a 360 degree camera suitable to capture the entire local environment.

Also shown in FIG. 8A is an access 835. In some embodiments, the remote participant virtual region 825 is part of a large virtual reality environment in which participants can navigate from one instance of one presentation and virtual region 825 to a different one via virtual access ways like 835.

In another embodiment, as depicted in FIG. 8B, a row of local participants 900 are positioned behind the remote participant virtual region 825. This can be captured and presented this way by locating the capture device 610 in front of the local participants. As shown in the image, the capture device has a viewable range V. With only a direction or even a 180 degree camera, the viewable range V would not capture local participants in this arrangement. As discussed above, in some embodiments the capture device is a 360 degree camera suitable to capture the entire local environment including local participants positioned with the capture device 610 between the participants and the presenter 600a.

FIG. 9A illustrates a perspective view of an illustrated presenter system setup with local participants 900. The presenter system includes display devices (e.g. 620a, 620b), a capture device 610, and a sound distribution device 660 (e.g. speakers). The capture device captures the presenter 600a allowing the environment to be disseminated to virtual reality environments of remote users. The secondary asset 700 captured from the visual display 710 is also disseminated. The displays 620 and speakers 660 allow for feedback to the presenter from the remote participants, in addition to the feedback from the local participants. The display 620 can present the remote participants in a variety of different ways. Using the environment depicted in FIG. 7A, for example, FIG. 9B illustrates the remote participants avatars (200b, 300b, 400b, 500b) positioned similar to how they perceive themselves in the virtual reality. In another example, FIG. 9C has the remote participants regrouped and sitting behind virtual assets different than the remote participant's perception in their virtual environment. For example, avatars 400b and 200b are together but behind separate desks not present in the virtual reality environment of FIG. 7A. Avatars 300b and 500b are together but behind a single desk not present in the virtual reality environment of FIG. 7A. In another example, FIG. 9D has the remote participant's avatars (200b, 300b, 400b, 500b) separated individually with biographical information (201b, 301b, 401b, 501b).

In accordance with various embodiments, the secondary asset 700 can be pulled digitally from the presenter's source material and disseminated as a secondary virtual asset in the various virtual reality environments. In another embodiments, a separate high resolution capture device 612 can specifically capture and feed a dedicated image or stream of the visual aid material to the system 100. The system 100 can then embed the high resolution image into the feed to the remote user virtual reality environments. This particular embodiment, is useful for stage displays such as white board, projections, etc. where the primary capture device does not pick up the details well.

In accordance with various embodiments, the avatars can navigate, explore, or otherwise experience the virtual region 825 independent of the live environment. As discussed herein, in some embodiments, the two environments are separated by a partition which is essentially where the live environment is displayed. However, in other embodiments, the live environments can surround the virtual region 825. In some of these embodiments, the avatars can still navigate and interact in the virtual region independent of the live environment. Due to the communication systems discussed above, the avatars can still get feedback or effect the live environment via their activities in the virtual region. In one example, the avatars can change locations with each other so as to interact with different avatars in the virtual environment while still observing and interacting with the streamed asset and in turn the real presenter environment.

In accordance with various embodiments, the avatars can have local virtual interactions in the virtual environment. In various examples, the virtual environment can allow adjacent avatars to discuss a topic without sharing the discussion with other avatars or the presenter. This interaction control can be based on proximity or independent controls.

The present disclosure is not to be limited in terms of the particular examples described in this application, which are intended as illustrations of various aspects. Many modifications and examples can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and examples are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can, of course, vary. It is also to be understood that the terminology used herein is for the purpose of describing particular examples only and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims), are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitations should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 items refers to groups having 1, 2, or 3 items. Similarly, a group having 1-5 items refers to groups having 1, 2, 3, 4, or 5 items, and so forth.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical viewer interfaces, and applications programs, one or more interaction devices such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

While various aspects and examples have been disclosed herein, other aspects and examples will be apparent to those skilled in the art. The various aspects and examples disclosed herein are for purposes of illustration and are not intended to be limiting, with the true scope and spirit being indicated by the following claims.

What is claimed is:

1. A virtual reality system, comprising:
a viewing device suitable for displaying display information from a virtual reality environment;
an information transmission device in communication with a virtual reality environment generation system suitable for generating the display information for display on the viewing device defining the virtual reality environment having a participant controlled asset, and a streaming asset having updatable content;
one or more controls or sensors suitable to allow a user to interact with the virtual reality environment;
a non-transitory memory containing computer-readable instructions operable to display and adjust the display information in the virtual reality environment; and
a processor configured to process instructions for carrying out the following steps for adjusting and displaying information in the virtual reality environment:
transmitting information related to position or activity of the avatar to the virtual reality environment generation system for subsequent transmission to be displayed at a location of capture of the streaming asset, and
receiving information from the virtual reality environment generation system that updates the streaming asset content.

2. The virtual reality system of claim 1, wherein the one or more controls or sensors are an input device configured to adjust the participant controlled asset within the virtual reality environment.

3. The virtual reality system of claim 2, wherein the participant controlled asset is an avatar representation of the participant for display in the virtual reality environment.

4. The virtual reality system of claim 1, wherein the streaming asset includes content from a real world event.

5. The virtual reality system of claim 4, wherein the streaming asset is a video feed of a portion of a captured live presentation.

6. The virtual reality system of claim 5, wherein the streaming asset is updated in near real-time based on progress of the presentation.

7. The virtual reality system of claim 3, wherein the participant can affect the streaming asset content by changing the position or activity of the participant's avatar.

8. The virtual reality system of claim 3, further comprising receiving information from the virtual reality environment generation system that locates additional avatars in the virtual reality environment that are also are experiencing the streaming asset.

9. A content capture system for creating a virtual reality asset in near real-time, comprising:
a viewing device suitable for displaying display information from a virtual reality environment;
a capture device configured to capture a real world activity;
an information transmission device in communication with a virtual reality environment generation system suitable for generating display information for display on the viewing device defining some portion of the virtual reality environment;
a non-transitory memory containing computer-readable instructions operable to display and adjust the display information in the virtual reality environment; and
a processor configured to process instructions for carrying out the following steps for adjusting and displaying information in the virtual reality environment:
receive information captured on the capture device related to a real world activity;
transmit the information to the virtual reality environment generation system for converting the information to a corresponding streaming asset that is embedded into the virtual reality environment and for subsequent transmission to an instance of the virtual reality environment on a participant device,
receive virtual reality environment information from the virtual reality environment generation system, the virtual reality environment information corresponding to the position or orientation of a participant asset of a participant that is engaging with the streaming asset, and
displaying the participant asset on the viewing device.

10. The content capture system of claim 9, wherein the participant asset is an avatar representation of a participant viewing the streaming asset content.

11. The content capture system of claim 9, wherein the streaming asset is a video feed of the real world event.

12. The content capture system of claim 11, wherein the real world event is a presentation.

13. The content capture system of claim 12, wherein the streaming asset is transmitted in near real-time as the presentation progresses.

14. The content capture system of claim 9, wherein the participant asset display on the viewing device is continually updated allowing feedback for the participant's engagement with the streaming asset.

15. The content capture system of claim 9, wherein the participant is a first participant having a first participant asset.

16. The content capture system of claim 15, further comprising receiving additional information from the virtual reality environment generation system corresponding to the position or orientation of a second participant asset of a second participant that is engaging with the streaming asset.

17. The content capture system of claim 15, further comprising displaying the second participant asset on the display device.

18. The content capture system of claim 17, further comprising receiving biographical information from the virtual reality environment generation system corresponding to the first participant or second participant.

19. The content capture system of claim 18, further comprising displaying the biographical information on the display device relative to the corresponding first participant or second participant.

20. A virtual reality system for partitioned virtual reality environments, comprising:
a viewing device suitable for displaying display information from a virtual reality environment;
an information transmission device in communication with a virtual reality environment generation system suitable for generating the display information for display on the viewing device defining the virtual reality environment having a participant controlled asset, and a streaming asset;
one or more controls or sensors suitable to allow a user to interact with the virtual reality environment;
a non-transitory memory containing computer-readable instructions operable to display and adjust the display information in the virtual reality environment; and
a processor configured to process instructions for carrying out the following steps for adjusting and displaying information in the virtual reality environment:
locating the participant controlled asset in a virtual region in the virtual reality environment, the virtual region including one or more virtual assets that the participant controlled asset can engage with,
locating the streaming asset within the virtual reality environment but outside of the virtual region such that the participant controlled asset is partitioned from the streaming asset, and
receiving information from the virtual reality environment generation system that updates the streaming asset content.
